(19) United States
(12) Patent Application Publication
(10) Pub. No.: US 2007/0180285 A1
(43) Pub. Date: Aug. 2, 2007

(54) Semiconductor device

(75) Inventor: Hiroki Dembo, Atsugi (JP)

Correspondence Address: ERIC ROBINSON, PMB 955, 21010 SOUTHBANK ST., POTOMAC FALLS, VA, 20165, US

(73) Assignee: Semiconductor Energy Laboratory Co., Ltd., Atsugi-shi (JP)

(21) Appl. No.: 11/698,943

(22) Filed: Jan. 29, 2007

(30) Foreign Application Priority Data
Jan. 31, 2006 (JP) 2006-023675

(51) Int. Cl. H04L 9/00; G06F 12/14; G06F 1/00; H04K 1/00; H04L 9/32; G06F 11/30

(52) U.S. Cl. 713/500; 380/29; 713/193

(57) ABSTRACT

To make it difficult to obtain a secret key from a power change or EM emission intercepted when an IC card encounters a power analysis attack or an electromagnetic wave analysis attack. An arithmetic circuit and a circuit for transmitting/receiving a signal to/from outside are included. The arithmetic circuit includes a central processing unit, an auxiliary arithmetic unit, a random number generator, and a read only memory. The read only memory stores a program for processing of blocking a side-channel attack in signal transmission/reception to/from outside. By additionally providing the random number generator and the auxiliary arithmetic unit, time change of physical data which leaks from an IC chip can be made more complex. This operation is executed by the program. Therefore, it takes time to obtain inside data from physical data intercepted by the third party, thereby security can be improved.

### TECHNICAL FIELD

The present invention relates to a semiconductor device. In particular, the present invention relates to a semiconductor device which transmits/receives signals to/from an external device by wireless communication. Note that a semiconductor device here means any device which can function by using semiconductor characteristics. For example, an IC chip for RFID (Radio Frequency Identification) (also called an ID chip, an IC tag, an ID tag, an RF tag, a wireless tag, an electronic tag, or a transponder) is also included in the category of the present invention.

### BACKGROUND ART

With development of computer technologies and improvement of image recognition technologies, data identification using a medium such as a bar code has widely spread and been used for identification of product data and the like. It is expected that the amount of data to be identified will further increase in the future. The data reading using a bar code, or the like is, however, disadvantageous in that a bar code reader is required to be in contact with the bar code and the amount of data stored in the bar code cannot be increased very much. Therefore, non-contact data identification and increase in storage capacity of a medium are required.

In view of the foregoing requirements, a non-contact IC chip for RFID (hereinafter referred to as an IC chip) and a reader/writer device (also called an interrogator; hereinafter referred to as a reader/writer) have been developed. The IC chip has a memory circuit to store necessary data, and the inside data is read with a reader/writer by a non-contact means, generally by a wireless means. It is expected that practical application of a data processing device for reading data stored in such an IC chip will allow commercial distribution and the like to be simplified and made cheaper while ensuring high security.

In recent years, a card equipped with an IC chip which can transmit and receive data without contact has gradually spread in various fields which require high security, such as a credit card or a bankcard. The card equipped with an IC chip reads/writes data from/to an external device without contact, via an antenna with a shape adapted to the frequency band used in transmitting/receiving data. In addition, in order that the third party cannot decrypt data by interception easily, data is encrypted when the data is read/written from/to the external device.

Such a card equipped with an IC chip processes a code with hardware and software dedicated for performing encryption calculation corresponding to encryption algorithm of DES (Data Encryption Standard), equipped together. For example, a method for processing encryption algorithm of DES quickly has been disclosed in Patent Reference 1 (Patent Reference 1: Japanese Published Patent Application No. Hei 11-212451).

According to Patent Reference 1, a secret key which has been stored in the IC chip has been used to decrypt DES (Data Encryption Standard). However, there is a method capable of decrypting the secret key, which is a side-channel attack. A side-channel attack is a method of attack in which an operating condition of encryption equipment is observed by various physical means to obtain important data inside the device. As the specific method of attack, there are a power analysis attack and an electromagnetic wave analysis attack. A power analysis attack is a method of attack in which measuring and statistical processing of power consumption are performed utilizing the correlation between the power consumption and a processing content of an IC card, to obtain data on the processing content (the secret key). Specifically, an attacker touches the IC card with a measuring probe to measure a change in power consumption, thereby the secret key is obtained.

There is a plurality of reports as examples of decrypting a secret key by using a power analysis attack (e.g., see Non-Patent References 1 to 3).

### (Non-Patent Reference 1)

### Paul Kocher, Joshua Jaffe, Benjamin Jun, “Introduction to Differential Power Analysis and Related Attacks”, 1998.

### (Non-Patent Reference 2)

### Bruce Schneier, “Side-Channel Attacks Against Cryptosystems”, Crypto-Gram Newsletter, 15 Jun. 1998.

### (Non-Patent Reference 3)

### Paul Kocher, Joshua Jaffe, Benjamin Jun, “Differential Power Analysis”, CRYPTO '99, pp. 388-397, 1999.

Electromagnetic wave analysis attack is a method of attack in which measuring and statistical processing of time change in EM (Electromagnetic) emission are performed utilizing the correlation between the EM emission to the surroundings during encryption calculation of the IC card and a processing content of the device, to obtain communication data on the processing content. Specifically, an attacker intercepts EM emission of the IC card by using a measuring probe, thereby the secret key is obtained.

There is the following report as an example of decrypting a secret key by using an electromagnetic wave analysis attack (e.g., see Non-Patent Reference 4).

### (Non-Patent Reference 4)

K. Gandolfi, C. Mourtel, F. Olivier, “Electromagnetic analysis: concrete results”, CHES2001, pp. 251-261, 13-16 May 2001.

If such a power analysis attack or an electromagnetic wave analysis attack is used, the secret key is figured out in a short time, so that high security required for a credit card or a bankcard cannot be secured.

### DISCLOSURE OF INVENTION

In view of the foregoing, an object of the present invention is to provide a semiconductor device which requires more time to obtain a secret key from a power change or EM emission intercepted when an IC card encounters a power analysis attack or an electromagnetic wave analysis attack.

One feature of the present invention is a semiconductor device having a circuit for transmitting/receiving a signal from outside and an arithmetic circuit for processing to block a side-channel attack by a signal from outside, in which the arithmetic circuit includes a first memory which stores a program for processing to block a side-channel attack by a signal from outside; a central processing unit for reading a program from the first memory and executing the program; an auxiliary arithmetic unit for performing an inverse transformation process of data based on a signal in accordance with an instruction of a program; a random number generator for generating random numbers for setting calculation time of an inverse transformation process; and a second memory which stores data which has been subjected to an inverse transformation process.

One feature of the present invention is a semiconductor device having a circuit for transmitting/receiving a signal from outside and an arithmetic circuit for processing to block a side-channel attack by a signal from outside, in which the arithmetic circuit includes a first memory which stores a program for processing to block a side-channel attack by a signal from outside; a central processing unit for reading a program from the first memory and executing the program so that an inverse transformation process of data based on a signal from outside is performed; a random number generator for generating random numbers for setting calculation time of an inverse transformation process; and a second memory which stores data which has been subjected to an inverse transformation process.

In the present invention, the signal from outside may be a signal including a frame start code, a flag code, a command code, a data code, a cyclic redundancy check code, and a frame end code.

In the present invention, the program may include a first routine for judging the kind of the signal from outside, and a second routine for judging the number of calculation of the inverse transformation process.

In the present invention, the arithmetic circuit may include a controller including an interface, a control register, a code extracting circuit, and an encoding circuit.

In the present invention, the circuit for transmitting/receiving a signal from outside may include an antenna, a resonant circuit, a power supply circuit, a reset circuit, a clock generating circuit, a demodulating circuit, and a modulating circuit.

In the present invention, the random number generator may include a memory cell array which is controlled by a decoder and a reading circuit including a first memory cell, and have a structure in which each value of the random numbers is determined by a difference between the threshold voltage of the first memory cell and the threshold voltage of a second memory cell which is selected from the memory cell array.

One feature of the present invention is an RFID IC chip, an ID chip, an IC tag, an ID tag, an RF tag, a wireless tag, an electronic tag, or a transponder equipped with the semiconductor device of the present invention.

In an IC chip having a function of blocking a side-channel attack, by additionally providing a random number generator and an auxiliary arithmetic unit, time change of physical data which leaks from the IC chip can be made more complex. Therefore, it takes time to obtain inside data from physical data intercepted by the third party, thereby security can be improved. Furthermore, in the IC chip having a function of blocking a side-channel attack, there is no need to remake the IC chip back to a stage of mask design regardless of change of the specification by change of the method of blocking the side-channel attack. Consequently, manufacturing cost can be reduced and manufacturing time can be shortened. Further, there is no concern for a defect of an IC chip remade by changing the mask design.

Conventionally, in the case of manufacturing an IC chip having a function of blocking a side-channel attack, a circuit of blocking a side-channel attack has been mounted in some cases. However, by adopting the present invention, a function of blocking a side-channel attack is stored in a read only memory, as a program, thereby the size of an IC chip can be reduced as compared to the case where the circuit having a function of blocking a side-channel attack is additionally provided. Accordingly, the present invention can contribute to reduction in weight of an IC chip, reduction in cost by increasing the number of IC chips obtainable from one substrate, and increase in a yield by reducing the number of transistors by the number for the circuit having a function of blocking a side-channel attack.

### BRIEF DESCRIPTION OF DRAWINGS

FIG. 1 is a block diagram of a semiconductor device of Embodiment Mode 1.

FIGS. 2A and 2B are block diagrams each of a memory of a semiconductor device of Embodiment Mode 1.

FIG. 3 is a block diagram of a signal of Embodiment Mode 1.

FIG. 4 is a flow chart showing a side-channel attack blocking mechanism of Embodiment Mode 1.

FIG. 5 is a flow chart showing a side-channel attack blocking mechanism of Embodiment Mode 1.

FIG. 6 is a flow chart showing a side-channel attack blocking mechanism of Embodiment Mode 1.

FIG. 7 is a flow chart showing a side-channel attack blocking mechanism of Embodiment Mode 1.

FIG. 8 is a flow chart showing a side-channel attack blocking mechanism of Embodiment Mode 1.

FIG. 9 is a flow chart showing a side-channel attack blocking mechanism of Embodiment Mode 1.

FIG. 10 is a block diagram of an auxiliary arithmetic unit of Embodiment Mode 1.

FIG. 11 is a flow chart showing a side-channel attack blocking mechanism of Embodiment Mode 2.

FIG. 12 is a block diagram of a semiconductor device of Embodiment Mode 2.

FIGS. 13A to 13E are cross-sectional diagrams of a semiconductor device of Embodiment Mode 3.

FIGS. 14A and 14B are cross-sectional diagrams of a semiconductor device of Embodiment Mode 4.

FIG. 15 is a block diagram of a semiconductor device of Embodiment Mode 5.

FIGS. 16A to 16D are diagrams of antenna shapes of Embodiment Mode 6.

FIGS. 17A to 17C are diagrams of antenna shapes of Embodiment Mode 7.

FIGS. 18A and 18B are circuit diagrams of a semiconductor device of Embodiment Mode 8 and FIG. 18C is a diagram showing variations of threshold voltage of a TFT.

FIG. 19 is a diagram showing a mode of a random number generator of Embodiment Mode 8.

FIG. 20 is a diagram showing an example of use of a semiconductor device of Embodiment Mode 9.

### BEST MODE FOR CARRYING OUT THE INVENTION

Although the present invention will be described below by way of embodiment modes with reference to the accompanying drawings, it is to be understood that various changes and modifications will be apparent to those skilled in the art. Therefore, unless such changes and modifications depart from the scope of the present invention, they should be construed as being included therein. Note that identical portions or the portions having the identical functions are denoted by the same reference numerals in the drawings for describing the embodiment modes; therefore, description thereof is not repeated.

### Embodiment Mode 1

This embodiment mode will describe a device structure and a flow chart for achieving a function of blocking a side-channel attack in the present invention.

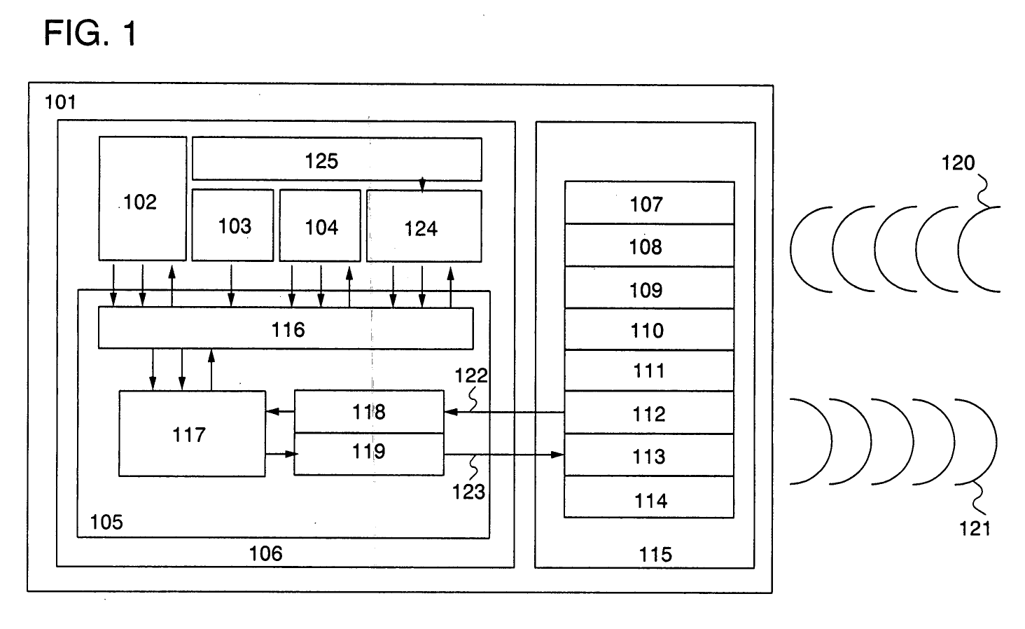

FIG. 1 is a block diagram of an IC chip for which a function of blocking a side-channel attack in the present invention is provided.

In FIG. 1, an IC chip 101 includes an arithmetic circuit 106 and an analog portion 115. The arithmetic circuit 106 includes a CPU (also called a Central Processing Unit, or a MPU (microprocessor)) 102, a ROM (also called a Read Only Memory) 103, a RAM (also called a Random Access Memory) 104, an auxiliary arithmetic unit 124, a random number generator 125, and a controller 105. The analog portion 115 includes an antenna 107, a resonant circuit 108, a power supply circuit 109, a reset circuit 110, a clock generating circuit 111, a demodulating circuit 112, a modulating circuit 113, and a power managing circuit 114. The controller 105 includes a CPU interface (CPUIF) 116, a control register 117, a code extracting circuit 118, and an encoding circuit 119. Note that in FIG. 1, although a reception signal 120 and a transmission signal 121 are shown separately as communication signals for simple description, their waveforms are actually overlapped with each other, and transmitted/received between the IC chip 101 and a reader/writer at the same time. The reception signal 120 is received by the antenna 107 and the resonant circuit 108, and then demodulated by the demodulating circuit 112. The transmission signal 121 is modulated by the modulating circuit 113 and then transmitted from the antenna 107. Note that the reception signal and the transmission signal are expressions providing that the IC chip is seemed the subject; the IC chip receives a signal from outside and transmits a signal to outside. In this specification, a signal received by the IC chip from the reader/writer, in other words, a signal transmitted by the reader/writer is called a signal from outside, and reception by the IC chip and transmission by the reader/writer, of a signal from outside is called transmission/reception of a signal from outside.

Note that the ROM stores data of a program which functions in processing data received from the reader/writer (hereinafter referred to as a side-channel attack blocking program), and the RAM stores processing data of when the program functions. As the ROM, there is a mask ROM or the like. As the RAM, there is a static type memory (SRAM), a dynamic type memory (DRAM), or the like. Specifically, the data of the side-channel attack blocking program includes a plurality of routines (hereinafter referred to as side-channel attack blocking routines) for blocking a side-channel attack which measures a change in power consumption of the IC chip.

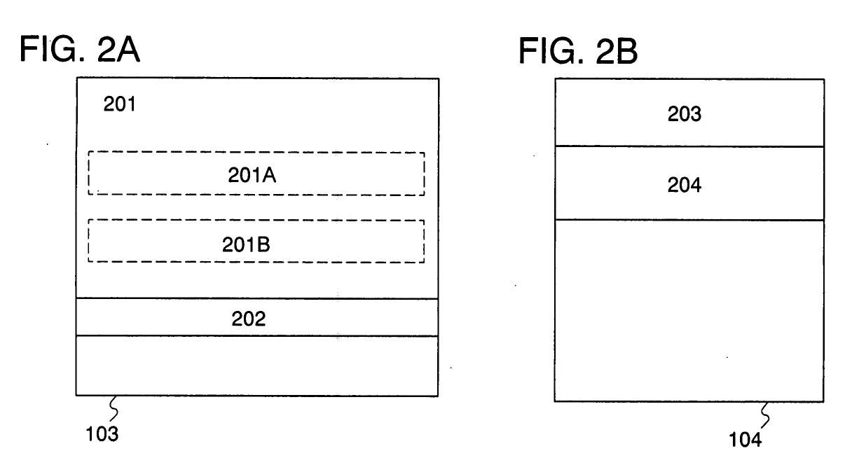

FIGS. 2A and 2B show address spaces of the ROM 103 and the RAM 104. The ROM 103 stores a side-channel attack blocking program 201 and a secret key 202. The side-channel attack blocking program 201 includes a command judging routine 201A, and a round judging routine 201B. The command judging routine 201A refers to a program code having a function of performing a judging process of a particular command. The round judging routine 201B refers to a program code having a function of performing a judging process of a round number in a decryption process. These plural routines will be described later in more detail.

The RAM 104 includes a transmission data register 203 and a reception data register 204. The transmission data register 203 has a function of storing data transmitted by the IC chip. The reception data register 204 has a function of storing data received by the IC chip. The RAM 104 has a smaller amount of data compared with the ROM 103; therefore, the area of the RAM 104 is small.

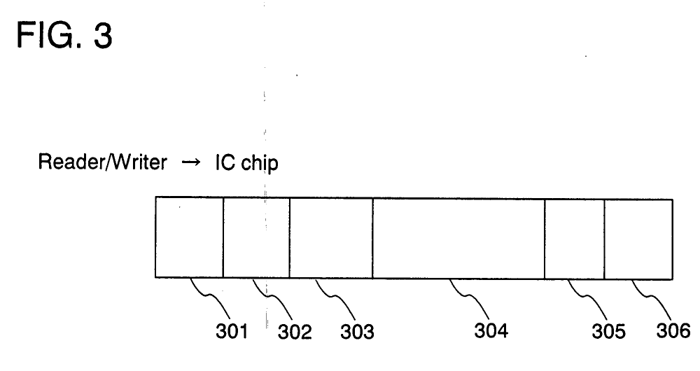

FIG. 3 shows a structure of a signal transmitted from the reader/writer to the IC chip, in other words, a signal received by the IC chip. A reception signal is a signal including a SOF (Start Of Frame) 301, a flag 302, a command 303, data 304, a CRC (Cyclic Redundancy Check) 305, and an EOF (End Of Frame) 306. The SOF 301 and the EOF 306 merely indicate signal start and signal termination. The flag 302 includes data on the kind of modulation such as ASK or FSK. The command 303 is a signal of prescribing whether the reader/writer reads the IC chip or not; when a signal is to be read, the command 303 has data of “inventory=1”, whereas in a state other than that (in the case of an instruction such as to stop reading), the command 303 has data of “inventory≠1”. The data 304 includes data of decryption. The CRC 305 includes data on a unique code which is generated from data to prevent misidentification of the data.

The random number generator 125 has a function of generating random numbers. Specifically, such a function is realized by utilizing variations in characteristics of a manufactured semiconductor device. Note that as the variations in characteristics of a manufactured semiconductor device, various variations caused by a manufacturing process (e.g., in film thickness, film property, or impurity concentration) are utilized. Data generated by the random number generator is difficult to be encrypted by a method other than electrical reading; therefore, high security can be ensured.

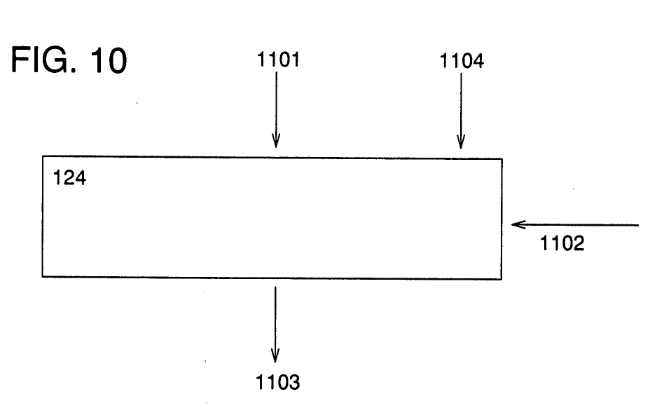

FIG. 10 shows a structure of the auxiliary arithmetic unit 124. The auxiliary arithmetic unit 124 includes a matrix of a plurality of switches, and has a function of calculating an input data 1101 by using a key 1102 and outputting its result as an output data 1103. Time required for the calculation of the auxiliary arithmetic unit 124 is determined based on a value of a switch parameter 1104. Specifically, such a function is realized by switching the matrix of a plurality of switches based on the value of the switch parameter 1104.

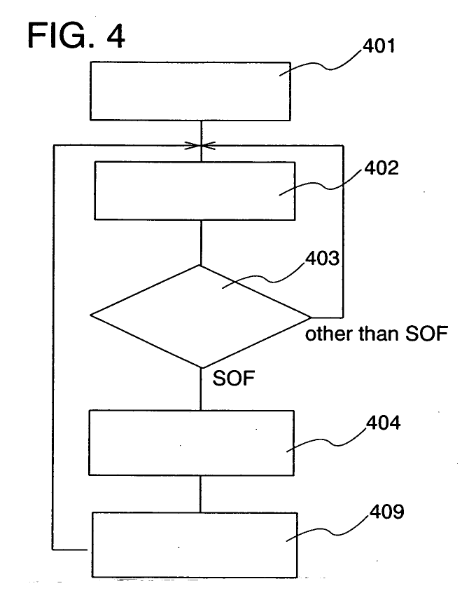

Next, an operation of the program having a function of blocking a side-channel attack in the IC chip in FIG. 1 will be described in accordance with a flow chart of FIG. 4.

First, the reset circuit 110 included in the IC chip resets the arithmetic circuit 106 by receiving the reception signal 120 (INITIAL RESET 401). When the reset is performed, the demodulating circuit 112 starts demodulation of the reception signal 120, and outputs demodulated reception data 122 to the code extracting circuit 118. The code extracting circuit 118 extracts a control code from the demodulated reception data 122 and writes it to the control register 117.

The CPU 102 included in the IC chip starts an operation when a signal from the code extracting circuit 118 is written to the control register 117 (START 402). The CPU 102 reads the side-channel attack blocking program from the ROM 103 (PROGRAM READ 404) and executes the side-channel attack blocking routine in the side-channel attack blocking program (ROUTINE EXECUTION 409), when the control code in the control register 117 includes the SOF (Start Of Frame) (CONTROL REGISTER JUDGEMENT 403). Meanwhile, the state returns to a state after INITIAL RESET 401 when the control code of the control register 117 does not include the SOF. Note that the CPU 102 returns to the state after INITIAL RESET 401 after the execution of the side-channel attack blocking routine is completed.

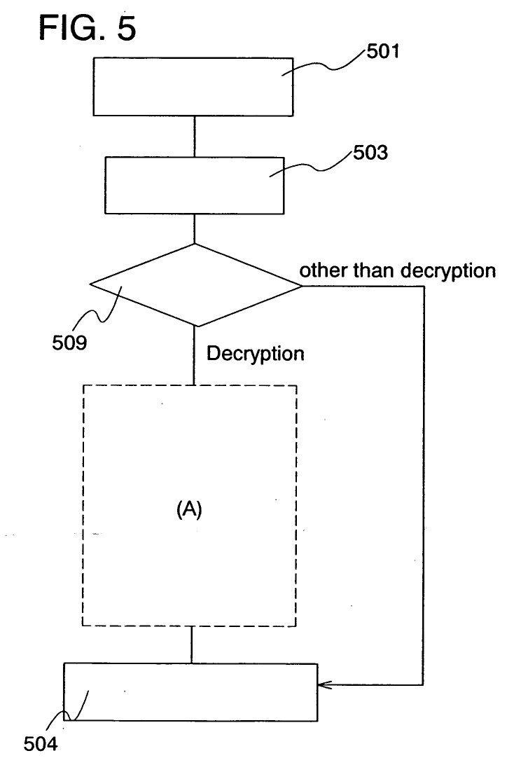

Next, the side-channel attack blocking routine in the side-channel attack blocking program to realize the function of blocking a side-channel attack in the IC chip in FIG. 1 will be described with reference to FIGS. 5 to 9.

First, an operation of the side-channel attack blocking routine is described in accordance with a flow chart shown in FIG. 5. The CPU 102 reads the side-channel attack blocking program from the ROM 103 and starts the side-channel attack blocking routine (ROUTINE START 501). The CPU 102 reads the command code of the control register 117 and writes into the RAM 104 (COMMAND ACQUISITION 503). The CPU 102 can make the process branch into a decryption process and a process other than the decryption depending on the kind of the command code (COMMAND JUDGEMENT 509), so that the rest of the plurality of routines can be further executed. Lastly, the CPU 102 terminates the plurality of routines to block a side-channel attack (TERMINATION 504).

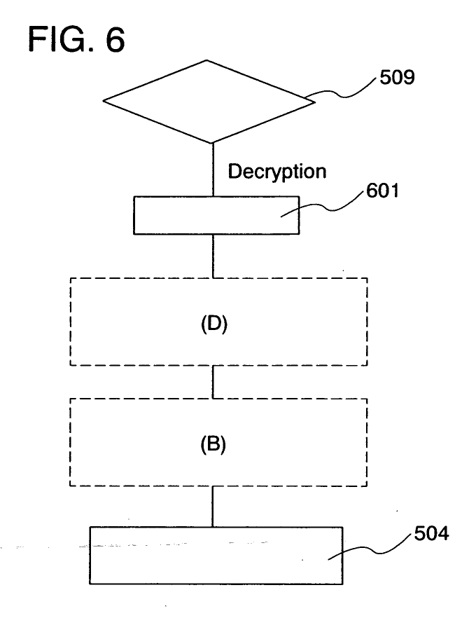

Next, details of the process corresponding to each command code in the IC chip in FIG. 1 are described in accordance with a flow chart of FIG. 6.

FIG. 6 shows a flow chart of a decryption command ((A) in FIG. 5). The CPU 102 reads the data code of the control register 117 and writes to the reception data register 204 (DATA ACQUISITION 601). The CPU 102 executes a first inverse transformation process ((D) in FIG. 6).

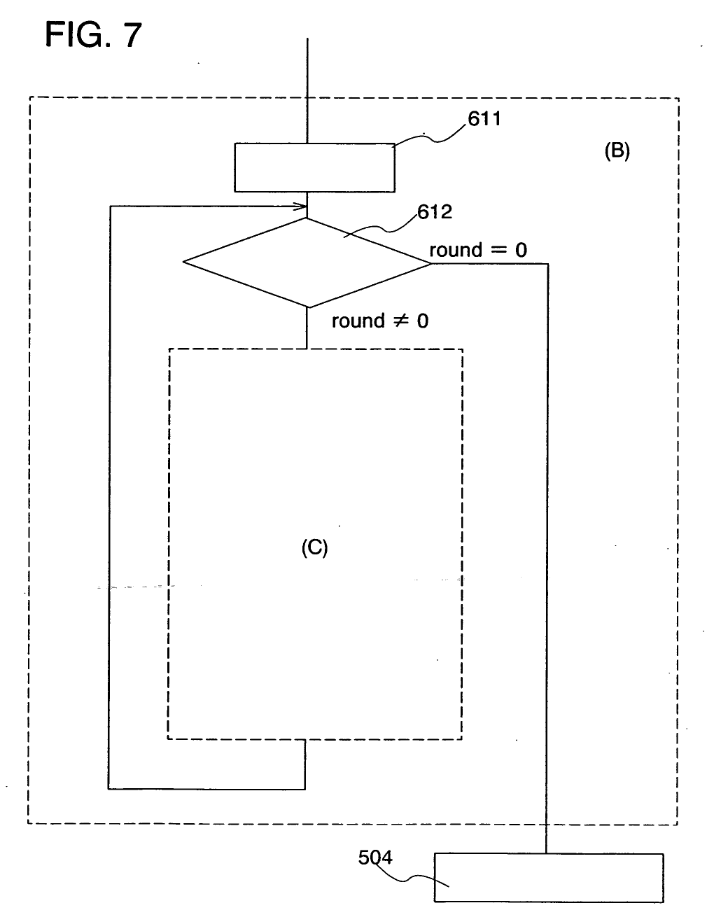

FIG. 7 shows a flow chart of round judgment ((B) in FIG. 6). The CPU 102 sets a value of a round flag to be N (8 in this embodiment mode) (VALUE OF ROUND FLAG=N 611). The CPU 102 makes the process branch depending on the value of the round flag (ROUND JUDGMENT 612). The CPU 102 executes a round process ((C) in FIG. 7) except in the case where the value of the round flag is 0. The CPU 102 terminates the side-channel attack blocking routine in the case where the value of the round flag is 0 (TERMINATION 504).

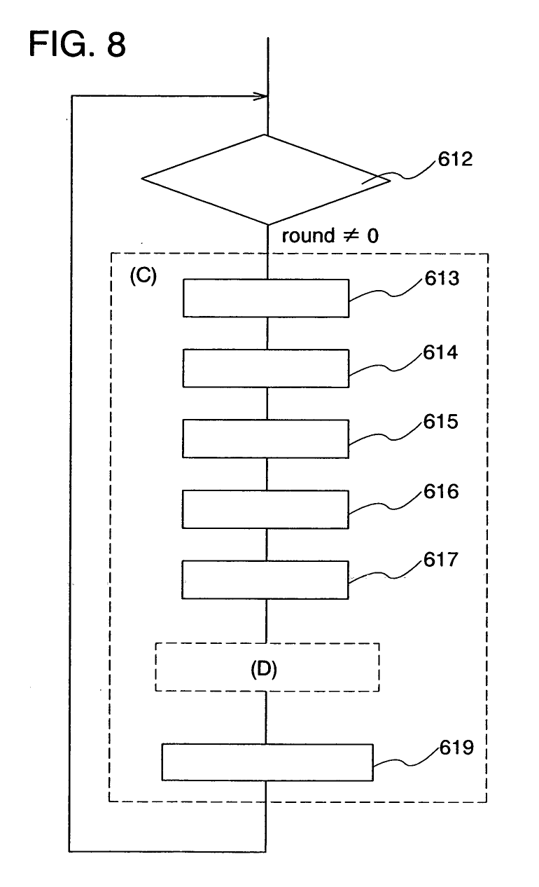

FIG. 8 shows a flow chart of the round process ((C) in FIG. 7). The CPU 102 reads the value of the reception data register 204, performs a second inverse transformation (an inverse transformation of a Pseudo-Hadamard transformation in this embodiment mode) to the value, and stores it again in the reception data register 204 (SECOND INVERSE TRANSFORMATION 613). The CPU 102 reads the value of the reception data register 204, performs an inverse transposition to the value, and stores it again in the reception data register 204 (INVERSE TRANSPOSITION 614). The CPU 102 performs a second inverse transformation 615 by the same method as the second inverse transformation 613. The CPU 102 performs an inverse transposition 616 by the same method as the inverse transposition 614. The CPU 102 performs a second inverse transformation 617 by the same method as the second inverse transformation 613. The CPU 102 executes a first inverse transformation process ((D) in FIG. 8). The CPU 102 reduces the value of the round flag by 1 (“ROUND=ROUND−1” 619).

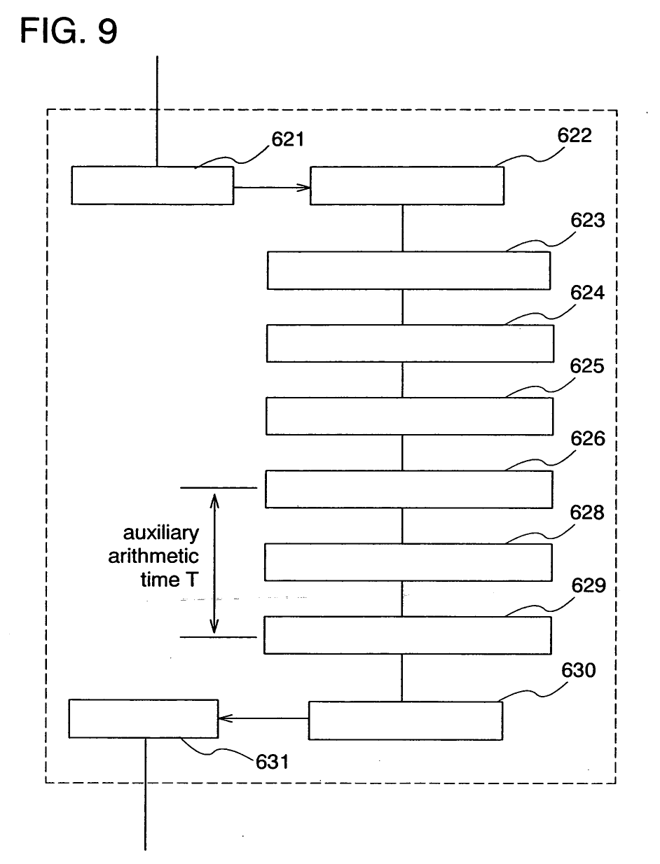

FIG. 9 shows a flow chart of the first inverse transformation process ((D) in FIGS. 6 and 8). The CPU 102 transmits the value of the reception data register 204 as “data before inverse transformation”, to the auxiliary arithmetic unit 124 (DATA TRANSMISSION BEFORE INVERSE TRANSFORMATION 621). The auxiliary arithmetic unit 124 starts an operation when the data before inverse transformation is received from the CPU 102 (START 622). The auxiliary arithmetic unit 124 reads a random number as the switch parameter 1104 from the random number generator 125 (RANDOM NUMBER READ 623). The auxiliary arithmetic unit 124 switches the switch matrix in the auxiliary arithmetic unit based on the value of the switch parameter 1104 (SWITCH MATRIX SWITCH 624). The auxiliary arithmetic unit 124 reads a secret key 202 as the key 1102 (KEY READ 625). The auxiliary arithmetic unit 124 inputs data before inverse transformation as the input data 1101 (DATA INPUT 626). The auxiliary arithmetic unit 124 performs inverse transformation (inverse transformation of exponential/logarithmic arithmetic using 45 as a base and multiplication/division process using 257 as a cardinal number, in this embodiment mode) to the input data by using the key (INVERSE TRANSFORMATION 628), and outputs it as the output data 1103 (DATA OUTPUT 629). The auxiliary arithmetic unit 124 transmits the output data 1103 as data after inverse transformation to the CPU 102 to terminate the operation (TERMINATION 630). The CPU 102 receives the data after inverse transformation when the auxiliary arithmetic unit 124 terminates the operation and stores the data in the reception data register 204 (RECEPTION OF DATA AFTER INVERSE TRANSFORMATION 631). Time from DATA INPUT 626 to DATA OUTPUT 629 is denoted by auxiliary arithmetic time T. In the auxiliary arithmetic unit 124, the auxiliary arithmetic time T is changed based on the random number value read from the random number generator 125.

In accordance with the above mode, in an IC chip having a function of blocking a side-channel attack, by additionally providing a random number generator and an auxiliary arithmetic unit, time change of physical data which leaks from the IC chip can be made more complex. Therefore, it takes time to obtain inside data from physical data intercepted by the third party, thereby security can be improved. Furthermore, in the IC chip having a function of blocking a side-channel attack, there is no need to remake the IC chip back to a stage of mask design regardless of change of the specification by change of the method of blocking the side-channel attack. Consequently, manufacturing cost can be reduced and manufacturing time can be shortened. Further, there is no concern for a defect of an IC chip remade by changing the mask design.

Conventionally, in the case of manufacturing an IC chip having a function of blocking a side-channel attack, a circuit of blocking a side-channel attack has been mounted in some cases. However, by adopting the present invention, a function of blocking a side-channel attack is stored in a read only memory, as a program, thereby the size of an IC chip can be reduced as compared to the case where the circuit having a function of blocking a side-channel attack is additionally provided. Accordingly, the present invention can contribute to reduction in weight of an IC chip, reduction in cost by increasing the number of IC chips obtainable from one substrate, and increase in a yield by reducing the number of transistors by the number for the circuit having a function of blocking a side-channel attack.

Note that this embodiment mode can be implemented in combination with another embodiment mode in this specification as appropriate.

### Embodiment Mode 2

Embodiment Mode 1 shows the structure in which the IC chip can perform the function of blocking a side-channel attack with the side-channel attack blocking program having the plurality of side-channel attack blocking routines, stored in the ROM. This embodiment mode will describe a device structure for realizing a function of blocking a side-channel attack, which is different from Embodiment Mode 1. Since a flow chart in this embodiment mode is similar to that of Embodiment Mode 1, description will be made using the drawings in Embodiment Mode 1 as needed.

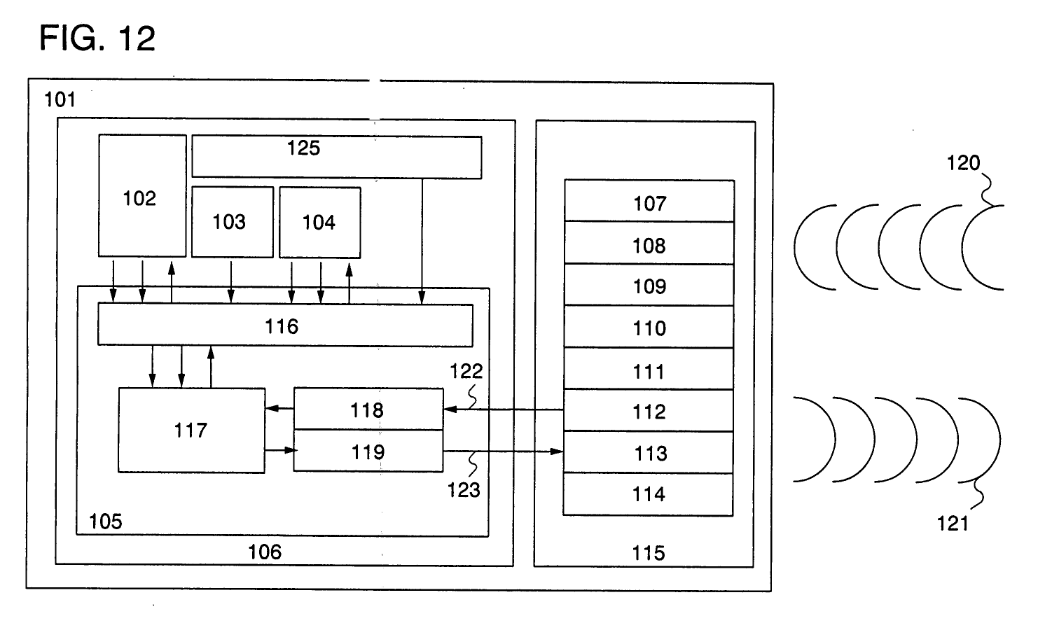

FIG. 12 is a block diagram of an IC chip for which a function of blocking a side-channel attack in the present invention is provided. FIG. 12 is a block diagram in which the auxiliary arithmetic unit 124 is removed from the block diagram of the IC chip of FIG. 1 in Embodiment Mode 1, and which includes, similarly to FIG. 1, the arithmetic circuit 106 including the CPU 102, the ROM 103, the RAM 104, and the random number generator 125, and the analog portion 115 including the antenna 107, the resonant circuit 108, the power supply circuit 109, the reset circuit 110, the clock generating circuit 111, the demodulating circuit 112, the modulating circuit 113, and the power managing circuit 114. The controller 105 includes the CPU interface (CPUIF) 116, the control register 117, the code extracting circuit 118, and the encoding circuit 119.

Although a process of a function of blocking a side-channel attack in such an IC chip is similar to that of Embodiment Mode 1, the first inverse transformation process of FIG. 9 in Embodiment Mode 1 is performed in the CPU 102 instead of the auxiliary arithmetic unit 124.

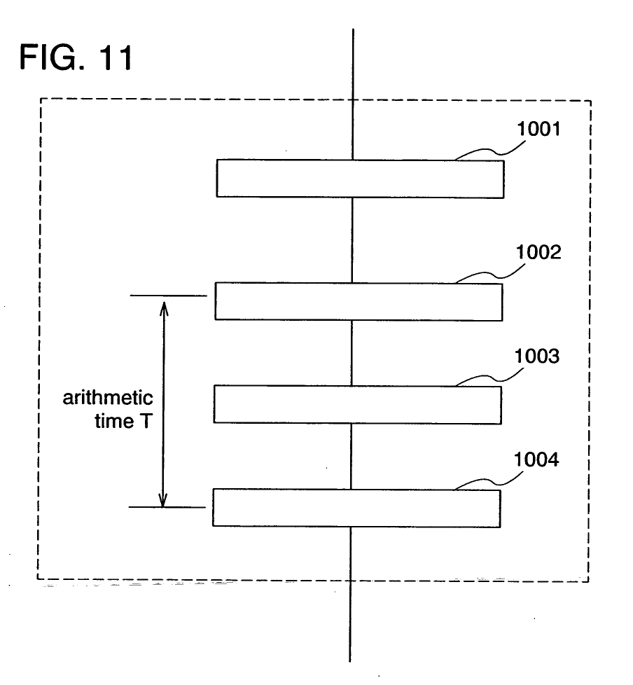

Next, an operation of the first inverse transformation process in the IC chip in FIG. 12 is described in accordance with a flow chart of FIG. 11.

In FIG. 11, the CPU 102 selects an inverse transformation pattern which is used in INVERSE TRANSFORMATION 1003 described later, based on an output value of the random number generator 125 (SELECTION OF INVERSE TRANSFORMATION PATTERN 1001). The CPU 102 starts inverse transformation (START OF INVERSE TRANSFORMATION 1002). The CPU 102 performs the inverse transformation (inverse transformation of exponential/logarithmic arithmetic using 45 as a base and multiplication/division process using 257 as a cardinal number, in this embodiment mode) to a value of the reception data register 204 by using the inverse transformation pattern selected by SELECTION OF INVERSE TRANSFORMATION PATTERN 1001 and the secret key 202 (INVERSE TRANSFORMATION 1003). The CPU 102 terminates the inverse transformation (TERMINATION OF INVERSE TRANSFORMATION 1004). Time from START OF INVERSE TRANSFORMATION 1002 to TERMINATION OF INVERSE TRANSFORMATION 1004 is denoted by arithmetic time T. In the CPU 102, the arithmetic time T is changed based on the random number value read from the random number generator 125.

By storing a program having such a function in the ROM and processing it with an instruction of the CPU 102, the auxiliary arithmetic unit 124 is not required and the size of a circuit can be reduced by the auxiliary arithmetic unit 124.

In accordance with the above mode, in an IC chip having a function of blocking a side-channel attack, time change of physical data which leaks from the IC chip can be made more complex. Therefore, it takes time to obtain inside data from physical data intercepted by the third party, thereby security can be improved. Furthermore, in the IC chip having a function of blocking a side-channel attack, there is no need to remake the IC chip back to a stage of mask design regardless of change of the specification by change of the method of blocking the side-channel attack. Consequently, manufacturing cost can be reduced and manufacturing time can be shortened. Further, there is no concern for a defect of an IC chip remade by changing the mask design.

Conventionally, in the case of manufacturing an IC chip having a function of blocking a side-channel attack, a circuit of blocking a side-channel attack has been mounted in some cases. However, by adopting the present invention, a function of blocking a side-channel attack is stored in a read only memory, as a program, thereby the size of an IC chip can be reduced as compared to the case where the circuit having a function of blocking a side-channel attack is additionally provided. Accordingly, the present invention can contribute to reduction in weight of an IC chip, reduction in cost by increasing the number of IC chips obtainable from one substrate, and increase in a yield by reducing the number of transistors by the number for the circuit having a function of blocking a side-channel attack.

Note that this embodiment mode can be implemented in combination with another embodiment mode in this specification as appropriate.

### Embodiment Mode 3

This embodiment mode will describe a mode of forming an IC chip by using a thin film transistor formed over an insulating substrate.

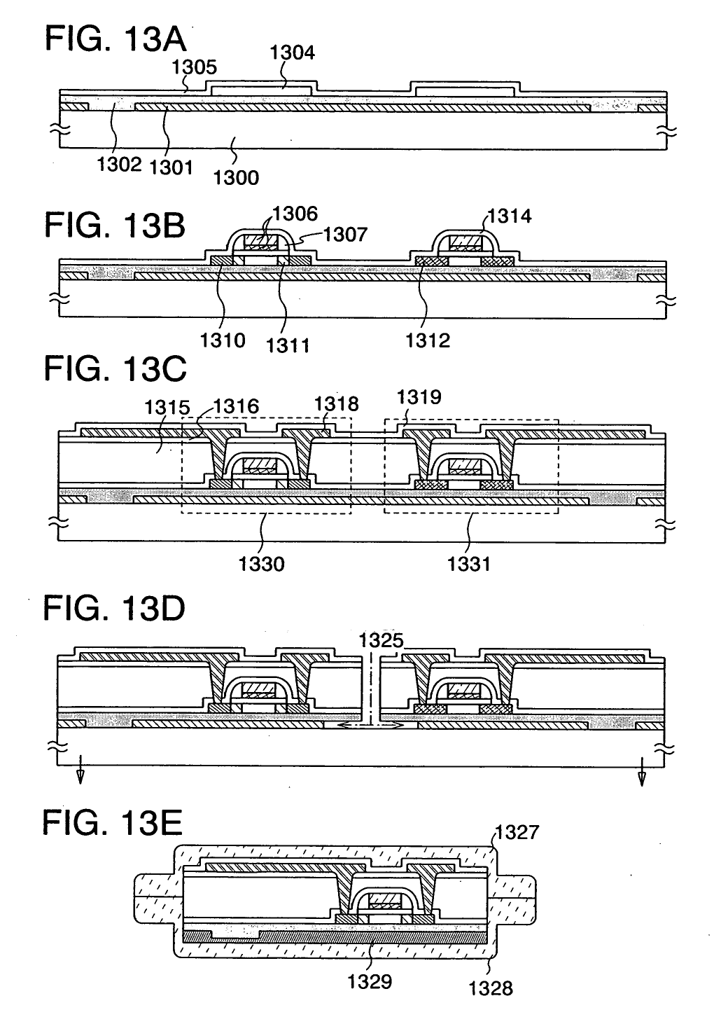

As shown in FIG. 13A, an insulating substrate 1300 is prepared. A glass substrate, a quartz substrate, a plastic substrate, or the like can be used as the insulating substrate 1300. Further, these substrates can be made thinner by, for example, polishing their back surfaces. Alternatively, a substrate formed by forming a layer using an insulating material on a conductive substrate formed of a metal element or the like or a semiconductor substrate formed of silicon or the like can be used. For example, by forming an IC chip over a plastic substrate, a highly flexible, lightweight, and thin device can be manufactured.

A peeling layer 1301 is selectively formed over the insulating substrate 1300. Needless to say, the peeling layer 1301 may be formed over the entire surface of the insulating substrate 1300. The peeling layer 1301 is formed of a single layer or a plural layers of a layer formed of an element selected from tungsten (W), molybdenum (Mo), titanium (Ti), tantalum (Ta), niobium (Nb), nickel (Ni), cobalt (Co), zirconium (Zr), zinc (Zn), ruthenium (Ru), rhodium (Rh), palladium (Pd), osmium (Os), iridium (Ir), or silicon (Si), or an alloy material or a compound material containing such an element as a main component. A crystal structure of a layer containing silicon may be any of amorphous, microcrystal, and polycrystalline structures.

A base layer 1302 is formed over the peeling layer 1301. The base layer 1302 can have a single-layer structure or a multi-layer structure of an insulating material such as silicon oxide, silicon nitride, or silicon oxynitride. In the case of using a multi-layer structure, a silicon oxynitride layer is formed with a thickness of 10 to 200 nm inclusive (preferably 50 to 100 nm inclusive) as the first layer of the base layer 1302. The silicon oxynitride layer can be formed by using SiH₄, NH₃, N₂O, and H₂ as reaction gases by a plasma CVD method. Next, a silicon oxynitride layer is formed with a thickness of 50 to 200 nm inclusive (preferably 100 to 150 nm inclusive) as the second layer of the base layer 1302. The silicon oxynitride layer can be formed by using SiH₄ and N₂O as reaction gases by a plasma CVD method.

A semiconductor layer 1304 is formed over the base layer 1302. The semiconductor layer 1304 can be formed using a silicon semiconductor layer containing a silicon material, a material formed of silicon and germanium, or the like. A crystal structure of the semiconductor layer 1304 may be any of amorphous, microcrystal, and polycrystalline structures.

In the case of forming a polycrystalline semiconductor layer, there is a method in which heat treatment is performed to an amorphous semiconductor layer. Laser irradiation, a heating furnace, lamp irradiation, or the like can be given as examples of the heat treatment; one or a plurality thereof can be used.

For laser irradiation, a continuous wave laser beam (a CW laser) or a pulsed wave laser beam (a pulsed laser) can be used. As the laser beam, a laser beam emitted from one or a plurality of an Ar laser, a Kr laser, an excimer laser, a YAG laser, a Y₂O₃ laser, a YVO₄ laser, a YLF laser, a YAlO₃ laser, a glass laser, a ruby laser, an alexandrite laser, a Ti:sapphire laser, a copper vapor laser, and a gold vapor laser can be used. By irradiating the amorphous semiconductor layer with a fundamental wave of such a laser beam and any of a laser beam with a high harmonic, which is any of a second to fourth harmonic of the fundamental wave, a silicon layer having crystals with a large grain size can be obtained. As the harmonic, a second harmonic (532 nm) or a third harmonic (355 nm) of an Nd:YVO₄ laser (fundamental wave: 1064 nm) can be used. The laser irradiation requires a power density of approximately 0.01 to 100 MW/cm² (preferably 0.1 to 10 MW/cm²). The laser is emitted at a scanning rate of approximately 10 to 2000 cm/sec.

Note that a CW laser with a fundamental wave and a CW laser with a harmonic may be used for the irradiation, or a CW laser with a fundamental wave and a pulsed laser with a harmonic may be used for the irradiation. By using a plurality of laser light, a wide range of energy regions can be treated.

It is also possible to use a pulsed laser beam with a repetition rate such that an amorphous silicon layer melted by a laser beam can be irradiated with the next pulsed laser beam before being solidified. By using a laser beam with such a repetition rate, a silicon layer with crystal grains that are grown continuously in the scan direction can be obtained. Such a repetition rate of a laser beam is 10 MHz or higher, which is much higher than the generally used frequency band of the several tens to several hundreds of Hz.

In the case of using an annealing furnace for the heat treatment, an amorphous semiconductor layer is heated at a temperature of 400 to 550° C. for 2 to 20 hours. At this time, the temperature is preferably set in plural stages in the range of 400 to 550° C. so as to increase gradually. Hydrogen or the like contained in the amorphous semiconductor layer is exhausted in the first low temperature heating step at about 400° C., which leads to reduction in roughness of the surface caused by crystallization.

In the aforementioned heat treatment, a metal for promoting crystallization of a semiconductor layer, such as nickel (Ni), is added. For example, when the amorphous silicon layer may be coated with a solution containing nickel and subjected to the heat treatment. The heating temperature can be reduced and a polycrystalline silicon layer with a continuous crystal grain boundary can be obtained by such heat treatment using a metal. As the metal for promoting the crystallization, as well as Ni, iron (Fe), ruthenium (Ru), rhodium (Rh), palladium (Pd), osmium (Os), iridium (Ir), platinum (Pt), copper (Cu), silver (Au), or the like can be used.

Since the metal for promoting the crystallization becomes a source of pollution of a memory cell or the like, it is desirable that a gettering step of removing the metal be performed after the semiconductor layer is crystallized. In the gettering step, after the semiconductor layer is crystallized, a layer functioning as a gettering sink is formed on the semiconductor layer and heated, so that the metal moves to the gettering sink. As the gettering sink, a polycrystalline semiconductor layer or a semiconductor layer doped with an impurity can be used. For example, a polycrystalline semiconductor layer doped with an inert element such as argon may be formed on the polycrystalline silicon layer and used as the gettering sink. By adding an inert element into the gettering sink, distortion occurs and the metal can be captured more efficiently. Alternatively, the metal can be captured by adding an element such as phosphorus into a part of a semiconductor layer of a TFT, without forming a gettering sink.

The semiconductor layer thus formed is processed into a predetermined shape to form an island-shaped semiconductor layer 1304. As a processing method, etching is performed using a mask formed by photolithography. As the etching, wet etching or dry etching can be performed.

An insulating layer functioning as a gate insulating layer 1305 is formed so as to cover the semiconductor layer 1304. The gate insulating layer 1305 can be formed using a similar material and a similar method to the base layer 1302.

As shown in FIG. 13B, a conductive layer functioning as a gate electrode layer 1306 is formed over the gate insulating layer 1305. The gate electrode layer 1306 can be formed using a film formed of an element of aluminum (Al), titanium (Ti), molybdenum (Mo), tantalum (Ta), tungsten (W), or silicon (Si), or using an alloy film containing such an element. The gate electrode layer 1306 can have a single-layer structure or a multi-layer structure. As the multi-layer structure, a multi-layer structure of tantalum nitride and tungsten can be used. The gate electrode layer 1306 is processed by etching using a mask formed by photolithography. As the etching, wet etching or dry etching can be performed.

An insulator called a sidewall 1307 is formed on a side surface of the gate electrode layer 1306. The sidewall 1307 can be formed using a similar material and a similar method to the base layer 1302. Further, an edge portion of the sidewall 1307 is tapered by isotropic etching. The sidewall 1307 can prevent a short channel effect generated as the gate length becomes narrow. The short channel effect is more commonly seen in n-channel TFTs, so the sidewall 1307 is preferably provided on a side surface of a gate electrode of, at least, an n-channel TFT.

Then, the gate insulating layer 1305 is etched. As a result, a part of the semiconductor layer 1304 and the base layer 1302 are exposed. As the etching, wet etching or dry etching can be performed.

Next, using the gate electrode layer 1306 and the sidewall 1307, the semiconductor layer 1304 is doped with an impurity element to form high concentration impurity regions 1310 and 1312. In the case of forming an n-channel TFT, phosphorus (P) can be used as the impurity element, while boron (B) can be used in the case of forming a p-channel TFT. At this time, depending on the amount of impurity element, a low concentration impurity region is formed under the sidewall 1307. In this embodiment mode, a low concentration impurity region 1311 is formed only in an impurity region of the n-channel TFT, because the low concentration impurity region 1311 can prevent a short channel effect from occurring. A structure having such a low concentration impurity region is called an LDD (Lightly Doped Drain) structure.

Next, an insulating layer 1314 is formed so as to cover the base layer 1302, the semiconductor layer 1304, the gate electrode layer 1306, and the sidewall 1307. The insulating layer 1314 may be formed of a material containing silicon by a CVD method.

After forming the insulating layer 1314, heat treatment is performed as required. The heat treatment can be performed using a similar method to that of the aforementioned crystallization. By the heat treatment, the impurity regions can be activated. The insulating layer 1314 formed by a CVD method contains a lot of hydrogen, so roughness of a film in the impurity regions can be reduced since the hydrogen is dispersed by the heat treatment.

As shown in FIG. 13C, insulating layers 1315 and 1316 which function as interlayer films are formed. An inorganic material or an organic material can be used for the insulating layers 1315 and 1316. As the inorganic material, silicon oxide, silicon nitride, silicon oxynitride, or the like can be used. As the organic material, polyimide, acrylic, polyamide, polyimide amide, resist, benzocyclobutene, siloxane, or polysilazane can be used. Note that siloxane has a skeleton structure formed of a bond of silicon (Si) and oxygen (O). As a substituent, an organic group containing at least hydrogen (e.g., an alkyl group or aromatic hydrocarbon) is used. A fluoro group may also be used as the substituent. As a further alternative, an organic group containing at least hydrogen, and a fluoro group may be used as the substituent. Polysilazane is formed of a polymer material including a bond of silicon (Si) and nitrogen (N) as a starting material. If an inorganic material is used, penetration of an impurity element can be prevented, while planarity can be enhanced if an organic material is used. Therefore, in this embodiment mode, an inorganic material is used for the insulating layer 1315 and an organic material is used for the insulating layer 1316.

Contact holes are formed in the insulating layers 1314, 1315, and 1316, and a wiring 1318 is formed. The wiring 1318 can be formed of a film formed of an element selected from aluminum (Al), titanium (Ti), molybdenum (Mo), tantalum (Ta), tungsten (W), and silicon (Si), or an alloy film containing such an element. The wiring 1318 can have a single-layer structure or a multi-layer structure. For example, tungsten, tungsten nitride, or the like used for the first layer, an alloy of aluminum and silicon (Al—Si) or an alloy of aluminum and titanium (Al—Ti) used for the second layer, and a titanium nitride film, a titanium film, or the like used as the third layer may be stacked sequentially. The wiring 1318 is processed by etching using a mask formed by photolithography. As the etching, wet etching or dry etching can be performed. The wiring 1318 is connected to the impurity regions in the semiconductor layer 1304, and such a wiring can be called a source electrode or a drain electrode.

In this manner, an n-channel TFT 1330 and a p-channel TFT 1331 can be formed.

After that, a protective film 1319 is formed over the wiring 1318 as required. The protective film 1319 can be formed of oxide containing silicon or of nitride containing silicon. For example, the protective film 1319 may be formed of silicon nitride. Consequently, penetration of moisture and oxygen can be prevented.

As shown in FIG. 13D, an opening is formed between the TFTs, and etchant 1325 is introduced. The opening can be formed by wet etching or dry etching. Note that the position where the opening is formed is not necessarily between the TFTs as long as the position is a region where the semiconductor layer 1304 is not formed. The etchant 1325 is, for wet etching, a mixed solution in which hydrofluoric acid is diluted with water or ammonium fluoride, a mixed solution of hydrofluoric acid and nitric acid, a mixed solution of hydrofluoric acid, nitric acid, and acetic acid, a mixed solution of hydrogen peroxide and sulfuric acid, a mixed solution of hydrogen peroxide, an ammonium solution, and water, a mixed solution of hydrogen peroxide, hydrochloric acid, and water, or the like. For dry etching, a gas containing halogen-based atoms or molecules, such as fluorine or a gas containing oxygen is used as the etchant 1325. It is preferable to use a gas or a solution containing halogen fluoride or an interhalogen compound, such as chlorine trifluoride (ClF₃), as the etchant.

The peeling layer 1301 is removed by the introduction of the etchant. As a result, the insulating substrate 1300 is peeled off. In this manner, a thin and lightweight IC chip can be formed.

Other than the method of introducing etchant, the insulating substrate 1300 may also be physically peeled off by a method of exposing the peeling layer 1301 by laser drawing, a method of cutting a side of the IC chip, or the like.

As shown in FIG. 13E, an IC chip can be completed by being covered with films 1327 and 1328. At this time, the films 1327 and 1328 may be attached to each other by using an adhesive layer 1329. A protective film may be provided for the films 1327 and 1328 to prevent penetration of moisture, oxygen, or the like. Further, since the protective film 1319 is formed over the wiring 1318, a protective film may be formed under the base layer 1302 or the adhesive layer 1329. The protective film can be formed of oxide containing silicon or nitride containing silicon.

The IC chip formed over the insulating substrate and peeled off the insulating substrate can be provided at low cost and can be lightweight. Furthermore, such an IC chip which is highly flexible can be attached to a curved surface.

This embodiment mode can be implemented in combination with another embodiment mode in this specification as appropriate. Therefore, in an IC chip having a function of blocking a side-channel attack of a semiconductor device of the present invention, time change of physical data which leaks from the IC chip can be made more complex. Therefore, it takes time to obtain inside data from physical data intercepted by the third party, thereby security can be improved. Furthermore, in the IC chip having a function of blocking a side-channel attack, there is no need to remake the IC chip back to a stage of mask design regardless of change of the specification by change of the method of blocking the side-channel attack. Consequently, manufacturing cost can be reduced and manufacturing time can be shortened. Further, there is no concern for a defect of an IC chip remade by changing the mask design.

Conventionally, in the case of manufacturing an IC chip having a function of blocking a side-channel attack, a circuit of blocking a side-channel attack has been mounted in some cases. However, by adopting the present invention, a function of blocking a side-channel attack is stored in a read only memory, as a program, thereby the size of an IC chip can be reduced as compared to the case where the circuit having a function of blocking a side-channel attack is additionally provided. Accordingly, the present invention can contribute to reduction in weight of an IC chip, reduction in cost by increasing the number of IC chips obtainable from one substrate, and increase in a yield by reducing the number of transistors by the number for the circuit having a function of blocking a side-channel attack.

### Embodiment Mode 4

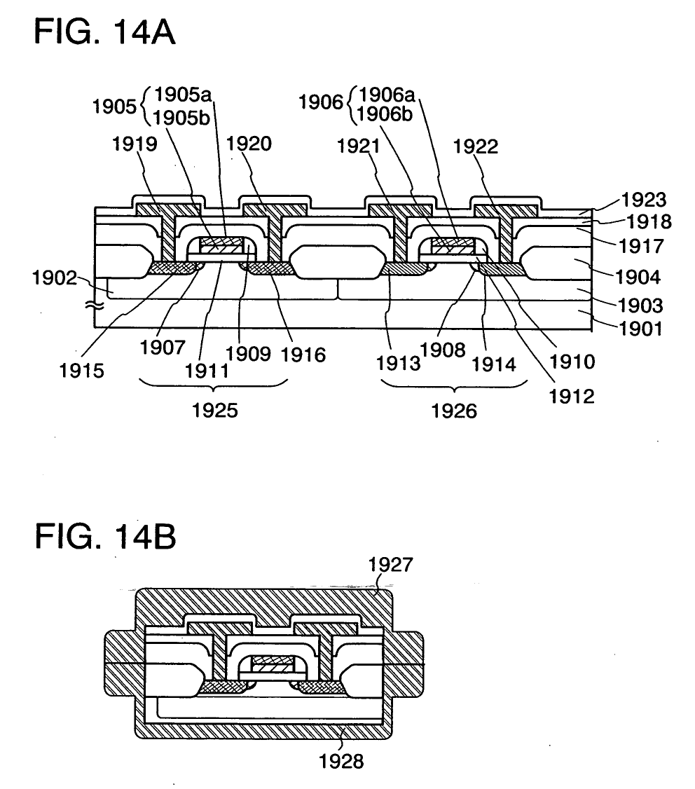

This embodiment mode will describe a mode of forming an IC chip by using a transistor formed over single-crystal silicon, with reference to FIGS. 14A and 14B.

First, a manufacturing process of a transistor is described with reference to FIG. 14A. A single-crystal silicon substrate 1901 is prepared. Then, an n-well 1902 is selectively formed in a first element formation region in a main surface (an element formation surface or a circuit formation surface) of the silicon substrate 1901, and a p-well 1903 is selectively formed in a second element formation region in the same surface. Further, the silicon substrate 1901 can be made thinner by, for example, polishing the back surface thereof. By making the silicon substrate 1901 thinner in advance, a lightweight and thin semiconductor device can be manufactured.

Next, a field oxide film 1904 to be an element isolation region for partitioning the first element formation region and the second element formation region is formed. The field oxide film 1904 is a thick thermal oxide film and may be formed by a LOCOS (local oxidation of silicon) method. Note that the method for partitioning the element formation regions is not limited to the LOCOS method. For example, by using a trench isolation method, the element isolation region may be formed to have a trench structure, or a LOCOS structure and a trench structure may be combined.

Next, a gate insulating film is formed by, for example, thermally oxidizing the surface of the silicon substrate. The gate insulating film may also be formed by a CVD method; and a silicon oxynitride film, a silicon oxide film, a silicon nitride film, or stacked layers thereof can be used.

Next, a multi-layer film of polysilicon layers 1905b and 1906b and silicide layers 1905a and 1906a is formed over the entire surface. By forming the multi-layer film by lithography and dry etching, gate electrodes 1905 and 1906 each having a polycide structure are formed over the gate insulating film. In order to reduce resistance, the polysilicon layers 1905b and 1906b may be doped with phosphorus (P) at a concentration of about 10²¹/cm³ in advance, or alternatively, an n-type impurity may be diffused into the polysilicon layers 1905b and 1906b at a high concentration after forming the polysilicon layers 1905b and 1906b. Further, the silicide layers 1905a and 1906a can be formed of a material such as molybdenum silicide (MoSiₓ), tungsten silicide (WSiₓ), tantalum siliside (TaSiₓ), or titanium silicide (TiSiₓ).

Next, the silicon semiconductor substrate is subjected to ion implantation through the gate insulating film to form an extension region. In this embodiment mode, an impurity region formed between a channel formation region and a source region or a drain region is called an extension region. The impurity concentration of extension regions 1907 and 1908 may be lower than, higher than, or the same as the impurity concentration of each of the source region and the drain region. That is, the impurity concentration of the extension region may be determined depending on the characteristics required for a semiconductor device.

Since this embodiment mode describes the case where a CMOS circuit applicable to the present invention is manufactured, the first element formation region for forming a p-channel FET is coated with a resist material, and arsenic (As) or phosphorus (P), which is an n-type impurity, is implanted into the silicon substrate. In addition, the second element formation region for forming an n-channel FET is coated with a resist material, and boron (B), which is a p-type impurity, is implanted into the silicon substrate.

Next, a first activation treatment is performed in order to activate the ion-implanted impurities and to recover crystal defects in the silicon substrate caused by the ion-implantation. In the activation treatment, the semiconductor substrate is heated up to a temperature around the melting point of Si.

Next, sidewalls 1909 and 1910 are formed on the side walls of the gate electrodes. For example, an insulating material layer formed of silicon oxide may be deposited on the entire surface by a CVD method, and the insulating material layer may be etched back to form the sidewalls. At the etch back, the gate insulating film may be selectively removed in a self-aligned manner. Alternatively, the gate insulating film may be etched after the etch back. Thus, gate insulating films 1911 and 1912, each having a width which is the sum of the width of the gate electrode and the width of the sidewalls provided on both sides of the gate electrode, are formed.

Next, the exposed silicon substrate is subjected to ion implantation, to form a source region and a drain region. The first element formation region for forming a p-channel FET is coated with a resist material, and arsenic (As) or phosphorus (P), which is an n-type impurity, is implanted into the silicon substrate to form a source region 1913 and a drain region 1914. In addition, the second element formation region for forming an n-channel FET is coated with a resist material, and boron (B), which is a p-type impurity, is implanted into the silicon substrate to form a source region 1915 and a drain region 1916.

Next a second activation treatment is performed in order to activate the ion-implanted impurities and to recover crystal defects in the silicon substrate caused by the ion-implantation.

After the activation, an interlayer insulating film, a plug electrode, a metal wiring, or the like are formed. A first interlayer insulating film 1917 is formed of a silicon oxide film, a silicon oxynitride film, or the like by a plasma CVD method or a low-pressure CVD method. Further, a second interlayer insulating film 1918 of phosphosilicate glass (PSG), borosilicate glass (BSG), or Phosphoborosilicate glass (PBSG) is formed thereover. The second interlayer insulating film 1918 is manufactured by a spin coating method or a normal-pressure CVD method to increase planarity. Note that the interlayer insulating film may have a single-layer structure or a multi-layer structure of three or more layers.

Source electrodes 1919 and 1921 and drain electrodes 1920 and 1922 are formed after contact holes reaching the source regions and the drain regions of the respective FETs in the first interlayer insulating film 1917 and the second interlayer insulating film 1918 are formed. Aluminum (Al), which is commonly used as a low resistance material, may be used for the source electrodes 1919 and 1921 and the drain electrodes 1920 and 1922. Alternatively, a multi-layer structure of Al and titanium (Ti) may be employed.

Note that the contact holes may be formed by electron beam direct writing lithography. Positive resist for electron beam lithography is formed on the entire surface of the first interlayer insulating film 1917 and the second interlayer insulating film 1918 by electron beam direct writing lithography, and a portion irradiated with an electron beam is dissolved using a developing solution. Then, holes are opened in the resist of a position where the contact holes are to be formed, and dry etching is performed using the resist as a mask, so that predetermined positions in the first interlayer insulating film 1917 and the second interlayer insulating film 1918 can be etched to form the contact holes.

Lastly, a passivation film 1923 is formed. In FIG. 14A, a transistor shown on the left is a p-channel transistor 1925 and a transistor shown on the right is an n-channel transistor 1926.

The passivation film 1923 is formed of a silicon nitride film, a silicon oxide film, or a silicon nitride oxide film by a plasma CVD method. Further an organic resin film may be formed instead of the silicon nitride film or the like, or an organic resin film may be stacked over the passivation film. As an organic resin material, polyimide, polyamide, acrylic, benzocyclobutene (BCB), or the like can be used. It is advantageous to use an organic resin film in that, for example, the method for forming the film is simple, parasitic capacitance can be reduced because of the low dielectric constant, and it is suitable for planarization. Needless to say, an organic resin film other than the ones mentioned above may also be used.

In this manner, the p-channel transistor 1925 and the n-channel transistor 1926 can be formed on the single crystalline substrate.

Note that a semiconductor device may be made thinner by, for example, polishing the back surface of the substrate on which the p-channel transistor 1925 and the n-channel transistor 1926 are formed. By making the silicon substrate thinner, a lightweight and thin semiconductor device can be manufactured.

Then, as shown in FIG. 14B, an IC chip can be completed by being covered with films 1927 and 1928. A protective film may be provided for the films 1927 and 1928 to prevent penetration of moisture, oxygen, or the like. The protective film can be formed of oxide containing silicon or nitride containing silicon. In addition, a pattern which is to be an antenna of the IC chip may be formed on the film.

A product which is reduced in size and lightweight can be provided by using such an IC chip formed over a single crystalline substrate. Further, a semiconductor device which is reduced in size can be made by using such an IC chip, and there are few variations in transistors, which is ideal.

This embodiment mode can be implemented in combination with another embodiment mode in this specification as appropriate. Therefore, in an IC chip having a function of blocking a side-channel attack of a semiconductor device of the present invention, time change of physical data which leaks from the IC chip can be made more complex. Therefore, it takes time to obtain inside data from physical data intercepted by the third party, thereby security can be improved. Furthermore, in the IC chip having a function of blocking a side-channel attack, there is no need to remake the IC chip back to a stage of mask design regardless of change of the specification by change of the method of blocking the side-channel attack. Consequently, manufacturing cost can be reduced and manufacturing time can be shortened. Further, there is no concern for a defect of an IC chip remade by changing the mask design.

Conventionally, in the case of manufacturing an IC chip having a function of blocking a side-channel attack, a circuit of blocking a side-channel attack has been mounted in some cases. However, by adopting the present invention, a function of blocking a side-channel attack is stored in a read only memory, as a program, thereby the size of an IC chip can be reduced as compared to the case where the circuit having a function of blocking a side-channel attack is additionally provided. Accordingly, the present invention can contribute to reduction in weight of an IC chip, reduction in cost by increasing the number of IC chips obtainable from one substrate, and increase in a yield by reducing the number of transistors by the number for the circuit having a function of blocking a side-channel attack.

### Embodiment Mode 5

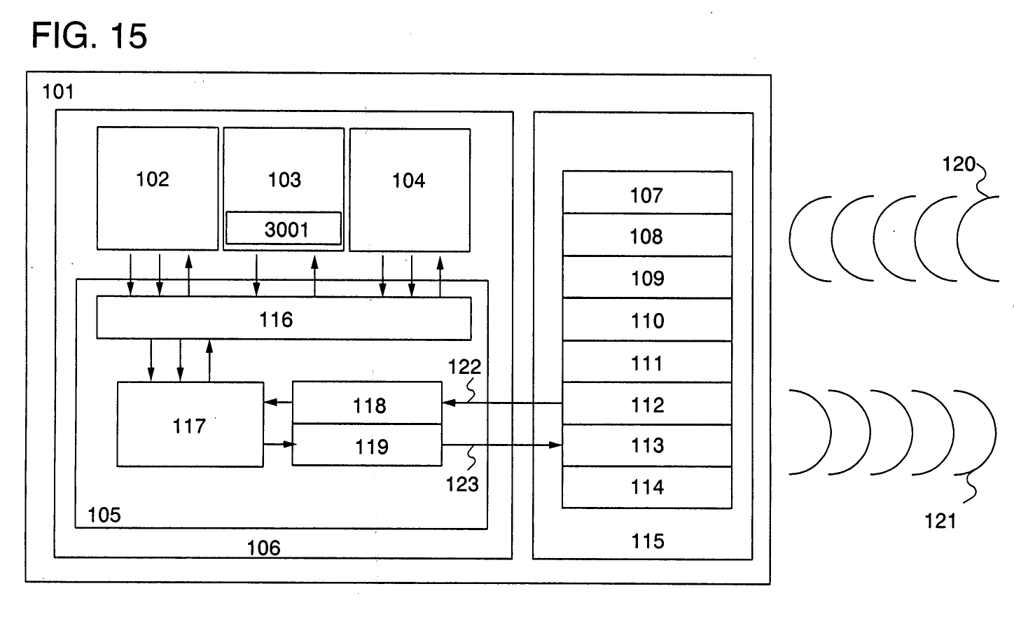

This embodiment mode will describe an IC chip having an encryption function as an example of a semiconductor device of the present invention, with reference to FIG. 15.

First, a block structure of an IC chip is described with reference to FIG. 15. In FIG. 15, the IC chip 101 includes the arithmetic circuit 106 including the CPU 102, the ROM 103, the RAM 104, and the controller 105, and the analog portion 115 including the antenna 107, the resonant circuit 108, the power supply circuit 109, the reset circuit 110, the clock generating circuit 111, the demodulating circuit 112, the modulating circuit 113, and the power managing circuit 114. The controller 105 includes the CPU interface (CPUIF) 116, the control register 117, the code extracting circuit 118, and the encoding circuit 119. Note that in FIG. 15, although communication signals are illustrated as the reception signal 120 and the transmission signal 121 separately for simple description, their waveforms are actually overlapped with each other, and the signals are transmitted and received between the IC chip 101 and the reader/writer at the same time. The reception signal 120 is received by the antenna 107 and the resonant circuit 108, and then demodulated by the demodulating circuit 112. The transmission signal 121 is modulated by the modulating circuit 113 and then transmitted from the antenna 107.

In FIG. 15, when the IC chip 101 is placed in a magnetic field formed by a communication signal, an induced electromotive force is generated by the antenna 107 and the resonant circuit 108. The induced electromotive force is held by electric capacitance of the power supply circuit 109, its potential is stabilized by the electric capacitance, and it is supplied as a power source voltage to each circuit in the IC chip 101. The reset circuit 110 generates an initial reset signal of the whole IC chip 101. For example, a signal which rises with a delay to a rise in the power source voltage is generated as a reset signal. The clock generating circuit 111 changes a frequency and a duty ratio of a clock signal in accordance with a control signal generated by the power managing circuit 114. The demodulating circuit 112 detects a change in amplitude of the reception signal 120 in an ASK mode as reception data 122 of “0” or “1”. The demodulating circuit 112 is, for example, a low pass filter. The modulating circuit 113 transmits transmission data by changing the amplitude of the transmission signal 121 in an ASK mode. For example, when transmission data 123 is “0”, a resonance point of the resonant circuit 108 is changed so as to change the amplitude of the communication signal. The power managing circuit 114 manages a power source voltage supplied from the power supply circuit 109 to the arithmetic circuit 106 and the current consumption in the arithmetic circuit 106, and generates a control signal for changing the frequency and the duty ratio of the clock signal at the clock generating circuit 111.

An operation of an IC chip of this embodiment mode is described. First, the reception signal 120 containing encoded text data, transmitted from the reader/writer is received by the IC chip 101. The reception signal 120 is demodulated by the demodulating circuit 112, divided into a control command, data on the encoded text, and the like by the code extracting circuit 118, and stored in the control register 117. Here, the control command is data to specify a response of the IC chip 101. For example, transmission of a unique ID number, operation stop, encryption, or the like is specified. Herein, a control command for encryption is received.

Next, in the arithmetic circuit 106, the CPU 102 decrypts (decodes) the encoded text by using a secret key 3001 stored in the ROM 103 in advance, in accordance with a decryption program stored in the ROM 103. The encoded text after being decoded (decoded text) is stored in the control register 117. At this time, the RAM 104 is used as a data storing region. Note that the CPU 102 accesses the ROM 103, the RAM 104, and the control register 117 through the CPUIF 116. The CPUIF 116 has a function of generating an access signal for any of the ROM 103, the RAM 104, and the control register 117 in accordance with an address requested by the CPU 102.

Lastly, the transmission data 123 is generated from the decoded text in the encoding circuit 119 and modulated in the modulating circuit 113, and then the transmission signal 121 is transmitted from the antenna 107 to the reader/writer.

Note that in this embodiment mode, as an arithmetic method, a method of processing by software, that is, a method in which an arithmetic circuit includes a CPU and a large-capacity memory and a program is executed by the CPU is described. However, the most suitable arithmetic method can be selected for the application and the arithmetic circuit can be formed based on the selected method. For example, as the arithmetic method, a method of processing by hardware or a method using both hardware and software can be used. In the method of processing by hardware, a dedicated circuit may be used to constitute the arithmetic circuit. In the method using both hardware and software, a dedicated circuit, a CPU, and a memory may be used to constitute the arithmetic circuit, in which a part of an arithmetic process may be performed by the dedicated circuit and a program of the rest of the arithmetic process may be performed by the CPU.

This embodiment mode can be implemented in combination with another embodiment mode in this specification as appropriate. Therefore, in an IC chip having a function of blocking a side-channel attack of a semiconductor device of the present invention, time change of physical data which leaks from the IC chip can be made more complex. Therefore, it takes time to obtain inside data from physical data intercepted by the third party, thereby security can be improved. Furthermore, in the IC chip having a function of blocking a side-channel attack, there is no need to remake the IC chip back to a stage of mask design regardless of change of the specification by change of the method of blocking the side-channel attack. Consequently, manufacturing cost can be reduced and manufacturing time can be shortened. Further, there is no concern for a defect of an IC chip remade by changing the mask design.

Conventionally, in the case of manufacturing an IC chip having a function of blocking a side-channel attack, a circuit of blocking a side-channel attack has been mounted in some cases. However, by adopting the present invention, a function of blocking a side-channel attack is stored in a read only memory, as a program, thereby the size of an IC chip can be reduced as compared to the case where the circuit having a function of blocking a side-channel attack is additionally provided. Accordingly, the present invention can contribute to reduction in weight of an IC chip, reduction in cost by increasing the number of IC chips obtainable from one substrate, and increase in a yield by reducing the number of transistors by the number for the circuit having a function of blocking a side-channel attack.

### Embodiment Mode 6

An antenna may have a size and a shape suitable for the application in the range determined by the Radio Law. A signal to be transmitted and received has a frequency of 125 kHz, 13.56 MHz, 915 MHz, 2.45 GHz, or the like, which is set by the ISO standard or the like. Specifically, a dipole antenna, a patch antenna, a loop antenna, a Yagi antenna, or the like may be used as the antenna. This embodiment mode will describe a shape of an antenna connected to an IC chip.

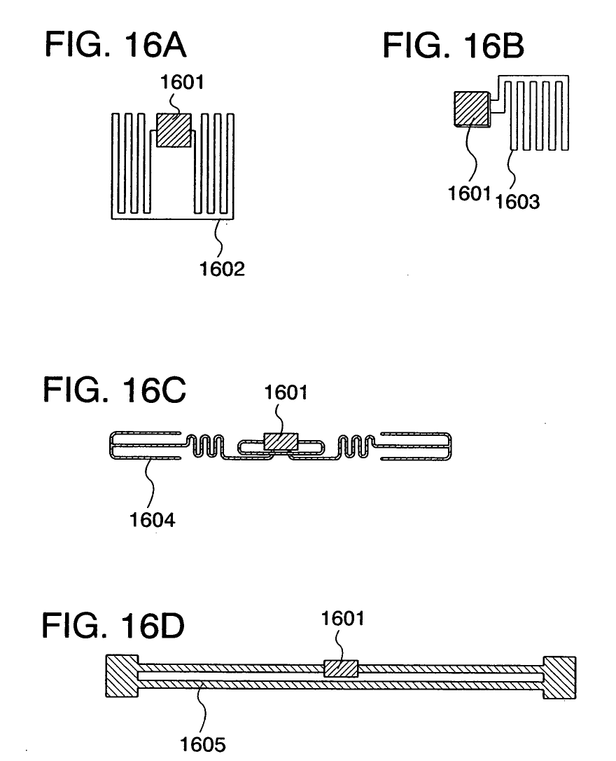

FIG. 16A shows an antenna 1602 connected to an IC chip 1601. In FIG. 16A, the IC chip 1601 is provided in a center portion and the antenna 1602 is connected to a connecting terminal of the IC chip 1601. In order to ensure the enough length of the antenna, the antenna 1602 is folded in a rectangular shape.

In FIG. 16B, the IC chip 1601 is provided on one end side and an antenna 1603 is connected to a connecting terminal of the IC chip 1601. In order to ensure the enough length of the antenna, the antenna 1603 is folded in a rectangular shape.

In FIG. 16C, an antenna 1604 which is folded in a rectangular shape is connected to both ends of the IC chip 1601.

In FIG. 16D, a linear antenna 1605 is connected to both ends of the IC chip 1601.

In this manner, the shape of an antenna can be selected, to be suitable for a structure, a polarized wave, or an application of an IC chip. Therefore, a folded dipole antenna may be used as the dipole antenna. A circular loop antenna or a square loop antenna may be used as the loop antenna. A circular patch antenna or a square patch antenna may be used as the patch antenna.

In the case of using a patch antenna, an antenna formed of a dielectric material such as ceramic may be used. With a high dielectric constant of a dielectric material to be used as a substrate for the patch antenna, the size of the antenna can be reduced. Moreover, as a patch antenna has high mechanical strength, it can be used repeatedly.

The dielectric material of a patch antenna can be formed of ceramic, an organic resin, a mixture of ceramic and an organic resin, or the like. As a typical example of ceramic, alumina, glass, forsterite, or the like can be given. Further, a plurality of ceramics may be mixed. In order to obtain a high dielectric constant, it is preferable to form a dielectric layer by using a ferroelectric material. A typical example of a ferroelectric material is barium titanate (BaTiO₃), lead titanate (PbTiO₃), strontium titanate (SrTiO₃), lead zirconate (PbZrO₃), lithium niobate (LiNbO₃), lead zirconate titanate (PZT), or the like. Furthermore, a plurality of ferroelectric materials may be mixed.

This embodiment mode can be implemented in combination with another embodiment mode in this specification as appropriate. Therefore, in an IC chip having a function of blocking a side-channel attack of a semiconductor device of the present invention, time change of physical data which leaks from the IC chip can be made more complex. Therefore, it takes time to obtain inside data from physical data intercepted by the third party, thereby security can be improved. Furthermore, in the IC chip having a function of blocking a side-channel attack, there is no need to remake the IC chip back to a stage of mask design regardless of change of the specification by change of the method of blocking the side-channel attack. Consequently, manufacturing cost can be reduced and manufacturing time can be shortened. Further, there is no concern for a defect of an IC chip remade by changing the mask design.

Conventionally, in the case of manufacturing an IC chip having a function of blocking a side-channel attack, a circuit of blocking a side-channel attack has been mounted in some cases. However, by adopting the present invention, a function of blocking a side-channel attack is stored in a read only memory, as a program, thereby the size of an IC chip can be reduced as compared to the case where the circuit having a function of blocking a side-channel attack is additionally provided. Accordingly, the present invention can contribute to reduction in weight of an IC chip, reduction in cost by increasing the number of IC chips obtainable from one substrate, and increase in a yield by reducing the number of transistors by the number for the circuit having a function of blocking a side-channel attack.

### Embodiment Mode 7

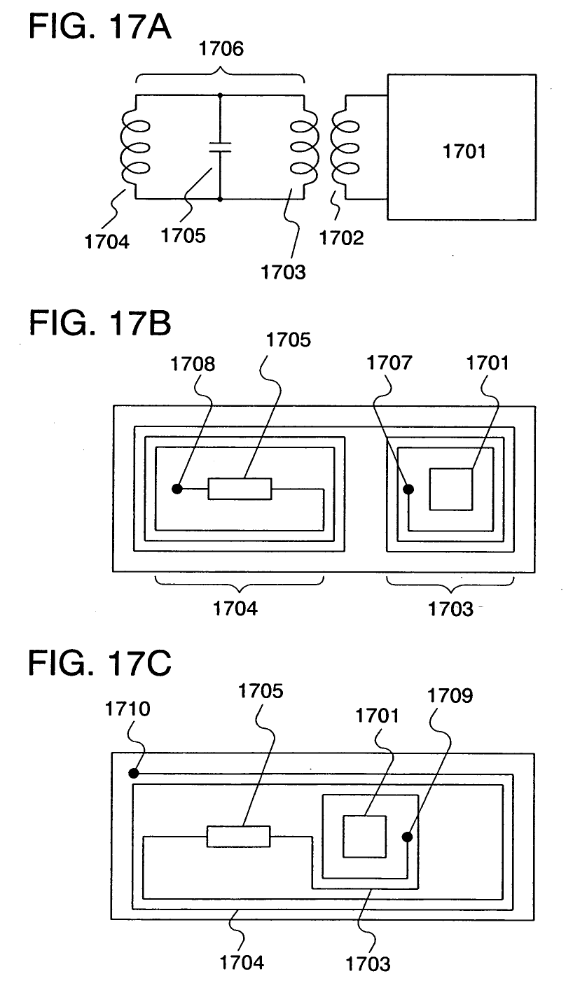

FIGS. 17A to 17C show a structure of an antenna, which is different from the modes described in Embodiment Mode 6. FIGS. 17A to 17C are a circuit diagram and layouts of a semiconductor device which includes a wireless chip, a first antenna, a second antenna, a third antenna, and a capacitor.

FIG. 17A is a circuit diagram of a semiconductor device of this embodiment mode. Herein, a first antenna (internal antenna) 1702 which is mounted on a wireless chip 1701, a second antenna 1703, a third antenna 1704, and a capacitor 1705 are included. The second antenna 1703, the third antenna 1704, and the capacitor 1705 form an external antenna 1706.

When the third antenna 1704 receives a communication signal from a reader/writer, induced electromotive force is generated in the third antenna 1704 by electromagnetic induction. By this induced electromotive force, an induction field is generated in the second antenna 1703. When the first antenna 1702 receives the induction field, the first antenna 1702 generates induced electromotive force by electromagnetic induction.

At this time, the induction field that the first antenna 1702 receives can be increased by increasing the inductance of the third antenna 1704. That is, a sufficient induction field can be supplied to operate the wireless chip 1701 even when the inductance of the first antenna 1702 is small. In the case where the first antenna 1702 is formed as an on-chip antenna, the inductance thereof cannot be increased very much because the area of the wireless chip 1701 is small. Therefore, it is difficult to increase the communication distance of the wireless chip 1701 by using only the first antenna 1702. However, by adopting the structure described in this embodiment mode, the communication distance can be increased even in the case of the wireless chip with an on-chip antenna.

FIG. 17B is a first mode of an antenna layout of the semiconductor device in this embodiment mode. FIG. 17B shows a mode in which the second antenna 1703 is formed outside the third antenna 1704. A first through-hole 1707 and a second through-hole 1708 are electrically connected to each other. The second antenna 1703, the third antenna 1704, and the capacitor 1705 form an external antenna. As the capacitor 1705, a chip capacitor, a film capacitor, or the like can be used. The layout shown in FIG. 17B by which an antenna with a narrow width can be formed is effective in providing a semiconductor device with a narrow width.

FIG. 17C is a second mode of the antenna layout of the semiconductor device in this embodiment mode. FIG. 17C shows a mode in which the second antenna 1703 is formed inside the third antenna 1704. A first through-hole 1709 and a second through-hole 1710 are electrically connected to each other. The second antenna 1703, the third antenna 1704, and the capacitor 1705 form an external antenna. As the capacitor 1705, a chip capacitor, a film capacitor, or the like can be used. The layout shown in FIG. 17C by which an antenna with a narrow width can be formed is effective in providing a semiconductor device with a narrow width.

By adopting the above-described embodiment mode, a high-performance semiconductor device with the communication distance increased can be provided.

This embodiment mode can be implemented in combination with another embodiment mode in this specification as appropriate. Therefore, in an IC chip having a function of blocking a side-channel attack of a semiconductor device of the present invention, time change of physical data which leaks from the IC chip can be made more complex. Therefore, it takes time to obtain inside data from physical data intercepted by the third party, thereby security can be improved. Furthermore, in the IC chip having a function of blocking a side-channel attack, there is no need to remake the IC chip back to a stage of mask design regardless of change of the specification by change of the method of blocking the side-channel attack. Consequently, manufacturing cost can be reduced and manufacturing time can be shortened. Further, there is no concern for a defect of an IC chip remade by changing the mask design.

Conventionally, in the case of manufacturing an IC chip having a function of blocking a side-channel attack, a circuit of blocking a side-channel attack has been mounted in some cases. However, by adopting the present invention, a function of blocking a side-channel attack is stored in a read only memory, as a program, thereby the size of an IC chip can be reduced as compared to the case where the circuit having a function of blocking a side-channel attack is additionally provided. Accordingly, the present invention can contribute to reduction in weight of an IC chip, reduction in cost by increasing the number of IC chips obtainable from one substrate, and increase in a yield by reducing the number of transistors by the number for the circuit having a function of blocking a side-channel attack.

### Embodiment Mode 8

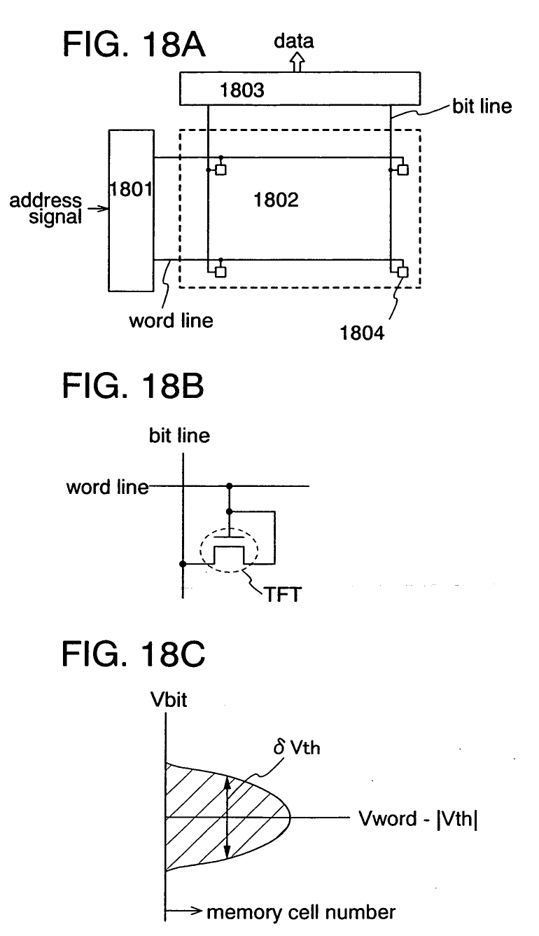

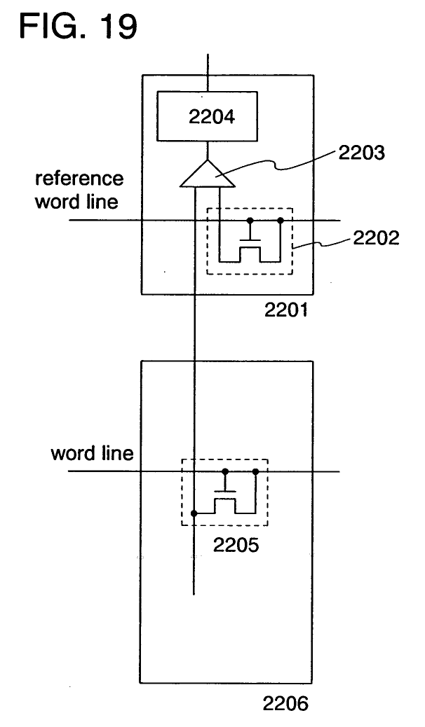

A random number generator is a memory circuit that generates random data whenever it is manufactured even when the same circuit configuration and layout is used and the same manufacturing process is used, which can be used as a random number generator which generates different random numbers depending on each IC chip. Hereinafter, modes of a random number generator will be described with reference to FIGS. 18A to 18C and FIG. 19.

FIG. 18A shows a typical mode of a random number generator. In FIG. 18A, the random number generator includes a decoder 1801, a memory cell array 1802, and a reading circuit 1803. The decoder 1801 receives an address signal and selects a word line of a corresponding address. Memory cells 1804 are arranged in matrix to form the memory cell array 1802, in which the memory cells of the same row are connected to the same word line while the memory cells of the same column are connected to the same bit line. The memory cells are selected through the word line, and data reading is performed through the bit line. The reading circuit 1803 selects the bit line and amplifies the potential of the bit line, thereby data is read.

FIG. 18B shows an example of a memory cell of a random number memory. The memory cell includes one TFT 1805, and one of a source electrode and a drain electrode of the TFT 1805 is connected to a bit line while the other and a gate electrode of the TFT 1805 are connected to a word line. When a voltage Vword higher than the threshold voltage Vth of the TFT 1805 is applied to the word line, a potential of (Vword−|Vth|) is charged in the bit line in this memory cell. The threshold voltage of the TFT has a variation due to grain patterns and process variations. Therefore, when the threshold voltage has a variation of δVth, an analog potential is charged in the bit line in accordance with a distribution shown in FIG. 18C. As a result, the memory cells output random potentials based on the variation in the threshold voltage of the TFT.

FIG. 19 shows a structure example of a reading circuit, which corresponds to one column of memory cells. A reading circuit 2201 includes a reference memory cell 2202, a differential amplifier circuit 2203, and a latch circuit 2204. When a word line is selected, a potential Vbit is charged in a bit line by a memory cell 2205 in a memory cell array 2206. On the other hand, a reference potential Vref is outputted from the reference memory cell 2202. The potential Vbit and the reference potential Vref are compared and amplified in the differential amplifier circuit 2203, and stored in the latch circuit 2204.

Note that the reference potential Vref is preferably close to an average of the bit line potential charged by the memory cell. Accordingly, 0 or 1 is assigned to data of the memory cell in each column of the memory cells with a probability of approximately ½, thereby uniform random numbers are generated. For example, it can be achieved by increasing the channel width of a TFT forming the reference memory cell.

In this manner, in accordance with a difference between the threshold voltage of the TFT forming the reference memory cell 2202 and the threshold voltage of the TFT forming the selected memory cell 2205, a one-bit random number is determined and stored in the latch circuit 2204. To be more exact, a random number is determined taking into consideration variations of a TFT for forming the differential amplifier circuit 2203. In either case, a random number is determined in accordance with variations in characteristics of TFTs. Thus, a random number generator which stores random fixed data can be formed without changing the manufacturing process.

Note that the above-mentioned random number generator can be manufactured by a normal TFT manufacturing technique, and can be manufactured by the same process as those for manufacturing other integrated circuits. Therefore, the random number generator can be manufactured without increase in process cost, and the process cost can be made lower than that of the case where a flash memory is manufactured.

Note also that since values stored in the random number memory circuit are random, the probability that the same ID is stored in different ID chips is not zero. However, for example, a capacity of about 128 bits can have 2128 random numbers. Therefore, the probability that the same random numbers are stored in different ID chips is substantially zero, which cannot be a problem.

By using such a random number generator and using its data as unique data (e.g., an identification number) of an ID chip, a photomask in forming a mask ROM can be prevented from being thrown away after being used only once, and besides, an ID chip can be manufactured at low cost without increase in process cost.

This embodiment mode can be implemented in combination with another embodiment mode in this specification as appropriate. Therefore, in an IC chip having a function of blocking a side-channel attack of a semiconductor device of the present invention, time change of physical data which leaks from the IC chip can be made more complex. Therefore, it takes time to obtain inside data from physical data intercepted by the third party, thereby security can be improved. Furthermore, in the IC chip having a function of blocking a side-channel attack, there is no need to remake the IC chip back to a stage of mask design regardless of change of the specification by change of the method of blocking the side-channel attack. Consequently, manufacturing cost can be reduced and manufacturing time can be shortened. Further, there is no concern for a defect of an IC chip remade by changing the mask design.

Conventionally, in the case of manufacturing an IC chip having a function of blocking a side-channel attack, a circuit of blocking a side-channel attack has been mounted in some cases. However, by adopting the present invention, a function of blocking a side-channel attack is stored in a read only memory, as a program, thereby the size of an IC chip can be reduced as compared to the case where the circuit having a function of blocking a side-channel attack is additionally provided. Accordingly, the present invention can contribute to reduction in weight of an IC chip, reduction in cost by increasing the number of IC chips obtainable from one substrate, and increase in a yield by reducing the number of transistors by the number for the circuit having a function of blocking a side-channel attack.

### Embodiment Mode 9

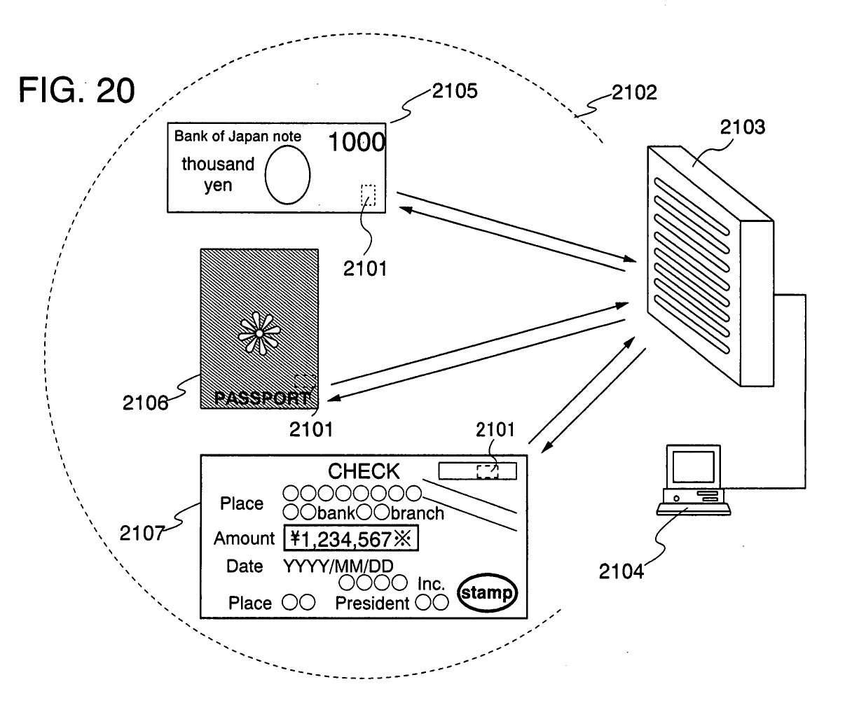

A semiconductor device of the present invention can be used as an IC chip. For example, it can be provided in paper money, coins, valuable securities, certificates, bearer bonds, or identification cards. Specific examples thereof will be described with reference to FIG. 20. The IC chip of the present invention has a function of blocking a side-channel attack in transmission/reception of signals between a reader/writer and the IC chip. Therefore, data in the IC chip attached to various articles such as those shown in FIG. 20 can be prevented from leaking. In addition, the IC chip can be made thinner by using a thin film transistor as shown in Embodiment Mode 3; therefore, the design of an article can be prevented from being spoiled.

FIG. 20 shows one mode of reading of the present invention. An IC chip 2101 shown in FIG. 20 is a non-contact IC chip which transmits/receives data with a reader/writer 2103 without contact. The IC chip 2101 within the range of an electric wave 2102 can communicate with the reader/writer 2103 wirelessly. Note that a distance between the IC chip 2101 and the reader/writer 2103, namely the distance of the area of the electric wave 2102, depends on a frequency which is used for the wireless communication. In addition, the frequency depends on the antenna length or the antenna shape used for the IC chip 2101.

In FIG. 20, a paper money 2105, a passport 2106, and a check 2107 exist within the range of the electric wave, and the reader/writer 2103 is electrically connected to a computer 2104 and performs reading of data on the articles, or the like. In FIG. 20, the reader/writer 2103 instantly reads each piece of data on the paper money 2105, the passport 2106, and the check 2107 each having the IC chip 2101 having a function of blocking a side-channel attack of the present invention, existing within the range of the electric wave 2102.

By providing the IC chip 2101 for the paper money 2105, the passport 2106, the check 2107, and the like, leakage of communication data between the reader/writer and the IC chip can be prevented. The IC chip 2101 may be attached to a surface of an article or embedded in an article. For example, the IC chip may be embedded in paper of a paper money, or embedded in an organic resin of a card made of the organic resin. In this manner, by providing the IC chip for the paper money 2105, the passport 2106, the check 2107, and the like, data leakage of a system of a financial institution or a public institution, or the like can be prevented.

In this manner, a semiconductor device of the present invention may be provided for any article; the semiconductor device of the present invention can also be used for certificates, insurance cards, season tickets, bankcards, credit cards, electronic keys, electronic money, or the like. Note that this embodiment mode can be implemented in combination with the above-described embodiment modes.

This embodiment mode can be implemented in combination with another embodiment mode in this specification as appropriate. Therefore, in an IC chip having a function of blocking a side-channel attack of a semiconductor device of the present invention, time change of physical data which leaks from the IC chip can be made more complex. Therefore, it takes time to obtain inside data from physical data intercepted by the third party, thereby security can be improved. Furthermore, in the IC chip having a function of blocking a side-channel attack, there is no need to remake the IC chip back to a stage of mask design regardless of change of the specification by change of the method of blocking the side-channel attack. Consequently, manufacturing cost can be reduced and manufacturing time can be shortened. Further, there is no concern for a defect of an IC chip remade by changing the mask design.

Conventionally, in the case of manufacturing an IC chip having a function of blocking a side-channel attack, a circuit of blocking a side-channel attack has been mounted in some cases. However, by adopting the present invention, a function of blocking a side-channel attack is stored in a read only memory, as a program, thereby the size of an IC chip can be reduced as compared to the case where the circuit having a function of blocking a side-channel attack is additionally provided. Accordingly, the present invention can contribute to reduction in weight of an IC chip, reduction in cost by increasing the number of IC chips obtainable from one substrate, and increase in a yield by reducing the number of transistors by the number for the circuit having a function of blocking a side-channel attack.

This application is based on Japanese Patent Application serial no. 2006-023675 filed in Japan Patent Office on 31th, Jan., 2006, the entire contents of which are hereby incorporated by reference.

1. A semiconductor device comprising:
a circuit for transmitting and receiving a signal from an outside; and
an arithmetic circuit for processing to block a side-channel attack by the signal from the outside, the arithmetic circuit comprising:
a first memory in which a side-channel attack blocking program for processing to block the side-channel attack is stored;
a central processing unit for reading the side-channel attack blocking program from the first memory and executing the side-channel attack blocking program;
an auxiliary arithmetic unit for performing an inverse transformation process of data based on the signal by the side-channel attack blocking program;
a random number generator for generating a random number for setting calculation time of the inverse transformation process; and
a second memory in which the inversed data is stored.

2. A semiconductor device comprising:
a circuit for transmitting and receiving a signal from an outside; and
an arithmetic circuit for processing to block a side-channel attack by the signal from the outside, the arithmetic circuit comprising:
a first memory in which a side-channel attack blocking program for processing to block a side-channel attack is stored;
a central processing unit for reading the side-channel attack blocking program from the first memory and executing the side-channel attack blocking program so that an inverse transformation process of data based on the signal is performed;
a random number generator for generating a random number for setting calculation time of the inverse transformation process; and
a second memory in which the inversed data is stored.

3. The semiconductor device according to claim 1, wherein the signal from the outside comprises a frame start code, a flag code, a command code, a data code, a cyclic redundancy check code, and a frame end code.

4. The semiconductor device according to claim 2, wherein the signal from the outside comprises a frame start code, a flag code, a command code, a data code, a cyclic redundancy check code, and a frame end code.

5. The semiconductor device according to claim 1, wherein the side-channel attack blocking program comprises a first routine for judging the kind of the signal from the outside, and a second routine for judging the number of calculation of the inverse transformation process.

6. The semiconductor device according to claim 2, wherein the side-channel attack blocking program comprises a first routine for judging the kind of the signal from the outside, and a second routine for judging the number of calculation of the inverse transformation process.

7. The semiconductor device according to claim 1, wherein the arithmetic circuit comprises a controller including an interface, a control register, a code extracting circuit, and an encoding circuit.

8. The semiconductor device according to claim 2, wherein the arithmetic circuit comprises a controller including an interface, a control register, a code extracting circuit, and an encoding circuit.

9. The semiconductor device according to claim 1, wherein the circuit for transmitting and receiving the signal from the outside comprises an antenna, a resonant circuit, a power supply circuit, a reset circuit, a clock generating circuit, a demodulating circuit, a modulating circuit, and a power managing circuit.

10. The semiconductor device according to claim 2, wherein the circuit for transmitting and receiving the signal from the outside comprises an antenna, a resonant circuit, a power supply circuit, a reset circuit, a clock generating circuit, a demodulating circuit, a modulating circuit, and a power managing circuit.

11. The semiconductor device according to claim 1,
wherein the random number generator comprises a memory cell array which is controlled by a decoder and a reading circuit including a first memory cell, and
wherein a value of the random number is determined by a difference between a threshold voltage of the first memory cell and a threshold voltage of a second memory cell which is selected from the memory cell array.

12. The semiconductor device according to claim 2,
wherein the random number generator comprises a memory cell array which is controlled by a decoder and a reading circuit including a first memory cell, and
wherein a value of the random number is determined by a difference between a threshold voltage of the first memory cell and a threshold voltage of a second memory cell which is selected from the memory cell array.

13. An RFID IC chip having the semiconductor device according to claim 1.

14. An RFID IC chip having the semiconductor device according to claim 2.

15. A semiconductor device comprising:
a memory in which a side-channel attack blocking program for processing to block a side-channel attack and a secret key are stored;
a central processing unit for reading the side-channel attack blocking program from the first memory and executing the side-channel attack blocking program;
an auxiliary arithmetic unit for performing an inverse transformation process of data based on the side-channel attack blocking program and the secret key; and
a random number generator for generating a random number for setting calculation time of the inverse transformation process.

16. A semiconductor device comprising:
a memory in which a side-channel attack blocking program for processing to block a side-channel attack and a secret key are stored;
a central processing unit for reading the side-channel attack blocking program from the first memory and executing the side-channel attack blocking program so that an inverse transformation process of data is performed based on the side-channel attack blocking program and the secret key; and
a random number generator for generating a random number for setting calculation time of the inverse transformation process.

17. The semiconductor device according to claim 15, wherein the side-channel attack blocking program comprises a first routine for judging the kind of the signal from the outside, and a second routine for judging the number of calculation of the inverse transformation process.

18. The semiconductor device according to claim 16, wherein the side-channel attack blocking program comprises a first routine for judging the kind of the signal from the outside, and a second routine for judging the number of calculation of the inverse transformation process.

19. The semiconductor device according to claim 15,
wherein the random number generator comprises a memory cell array which is controlled by a decoder and a reading circuit including a first memory cell, and
wherein a value of the random number is determined by a difference between a threshold voltage of the first memory cell and a threshold voltage of a second memory cell which is selected from the memory cell array.

20. The semiconductor device according to claim 16,
wherein the random number generator comprises a memory cell array which is controlled by a decoder and a reading circuit including a first memory cell, and
wherein a value of the random number is determined by a difference between a threshold voltage of the first memory cell and a threshold voltage of a second memory cell which is selected from the memory cell array.

21. An RFID IC chip having the semiconductor device according to claim 15.

22. An RFID IC chip having the semiconductor device according to claim 16.

23. The semiconductor device according to claim 1, wherein the first memory is a ROM.

24. The semiconductor device according to claim 2, wherein the first memory is a ROM.

25. The semiconductor device according to claim 15, wherein the memory is a ROM.

26. The semiconductor device according to claim 16, wherein the memory is a ROM.

27. The semiconductor device according to claim 1, wherein the second memory is a RAM.

28. The semiconductor device according to claim 2, wherein the second memory is a RAM.

29. A driving method of a semiconductor device comprising:
transmitting data into an auxiliary unit;
reading a random number from a random number generator;
reading a secret key from a memory;
transforming inversely the data based on the random number and the secret key in the auxiliary unit; and
changing an auxiliary arithmetic time by the random number.
